(19) United States
(12) Patent Application Publication
(10) Pub. No.: US 2026/0278005 A1
(43) Pub. Date: Sep. 17, 2026

(54) GRAPH-BASED MODELS WITH EXTENSION NODES

(71) Applicant: Infosys Limited, Bangalore (IN)

(72) Inventor: Steven SCHILDERS, Columbus, IN (US)

(73) Assignees: Infosys Limited, Bangalore (IN); InvertIT INC., Columbus, IN (US)

(21) Appl. No.: 19/081,873

(22) Filed: Mar. 17, 2025

(51) Int. Cl. G06F 16/901

(52) U.S. Cl. CPC G06F 16/9024

(57) ABSTRACT

An overlay system is provided that includes a storage element and processing circuitry coupled thereto. The storage element stores an executable graph-based model that includes a plurality of active nodes. Each active node has a functionality associated therewith. The processing circuitry receives a stimulus indicative of an extension operation and identifies, a first active node of the plurality of active nodes. The extension operation is associated with an extension of a first functionality of the first active node. The processing circuitry creates a first extension node associated with a first extended functionality that extends the first functionality indicated by the first stimulus. The processing circuitry associates, in response to the first stimulus, the first extension node with the first active node. The first extension node exhibits at least one of a group consisting of the first functionality or the first extended functionality.

### FIELD OF THE DISCLOSURE

Various embodiments of the present disclosure relate generally to graph-based models. More specifically, various embodiments of the present disclosure relate to implementation of extension nodes in graph-based models.

### BACKGROUND

Graph-based models have emerged as a fundamental tool in modern technology, widely employed across various domains, including marketing, research, social networks, and recommendation engines. These models offer an intuitive and efficient way to represent complex systems by organizing entities as nodes and their relationships as edges, enabling seamless visualization, modification, and analysis of data, dependencies, and interactions associated with the nodes.

In such graph-based models, nodes may be governed by specific rules that define their roles and restrictions within the system. Such roles and restrictions may leave data associated with the node as non-modifiable. For example, a node may be classified as an owned node or a leaf node. Owned nodes are typically associated with specific users, who maintain ownership and control over the node's data. While owned nodes can be shared with other users, the shared access is often restricted. Other users may utilize the data within the owned nodes as needed but are generally prohibited from modifying or altering the data.

On the other hand, leaf nodes represent terminal elements in the hierarchical structure of graph-based models. These nodes are designed to be non-inheritable and are intended for limited purposes. As such, the data associated with the leaf nodes are often non-modifiable, further restricting their flexibility and utility within the overall model.

These inherent limitations, such as the restricted modifiability of data, pose various challenges to the practical implementation and optimization of graph-based models. The inability to modify certain data may hinder the efficient utilization of these models, leading to complications in adapting them to dynamic requirements or evolving use cases.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for implementing extension nodes to facilitate extension of functionalities of active nodes in executable graph-based models are provided substantially as shown in, and described in connection with, at least one of the figures.

The methods and systems described herein provide an overlay system. The overlay system includes processing circuitry and a storage element coupled to the processing circuitry. The storage element is configured to store an executable graph-based model that includes a plurality of active nodes. Each active node has a functionality associated therewith. The processing circuitry is configured to receive a first stimulus indicative of a first extension operation. The processing circuitry is further configured to identify, from the plurality of active nodes, a first active node. The first extension operation is associated with an extension of a first functionality of the first active node. The processing circuitry is further configured to create, in the executable graph-based model, a first extension node associated with a first extended functionality. The first extended functionality extends the first functionality indicated by the first stimulus. The processing circuitry is further configured to associate, in response to the first stimulus, the first extension node with the first active node, such that the first extension node exhibits at least one of a group consisting of the first functionality or the first extended functionality.

In some embodiments, the first active node is one of a group consisting of a leaf node or an owned node, of the executable graph-based model.

In some embodiments, the first active node is further associated with a first node-type. The first node-type is one of a group consisting of: an edge node-type, a vertex node-type, a role node-type, or an overlay node-type.

In some embodiments, the first extension node is further associated with a first extension node-type. The first extension node-type is one of a group consisting of: an edge extension node-type, a vertex extension node-type, a role extension node-type, or an overlay extension node-type.

In some embodiments, the first active node is further associated with a first node-type and the first extension node is further associated with a first extension node-type. The first node-type is different from the first extension node-type.

In some embodiments, the first active node is further associated with a first node-type and the first extension node is further associated with a first extension node-type. Based on the first node-type being an edge node-type, the first extension node-type is an edge extension node-type. Based on the first node-type being a vertex node-type, the first extension node-type is a vertex extension node-type. Based on the first node-type being a role node-type, the first extension node-type is a role extension node-type. Based on the first node-type being an overlay node-type, the first extension node-type is an overlay extension node-type.

In some embodiments, the first extended functionality is one of a group consisting of a data functionality or an operational functionality.

In some embodiments, the processing circuitry is further configured to receive a second stimulus indicative of a second extension operation. The processing circuitry is further configured to identify, from the plurality of active nodes, the first active node. The second extension operation is associated with an extension of a second functionality of the first active node. The processing circuitry is further configured to create, in the executable graph-based model, a second extension node associated with a second extended functionality that extends the second functionality indicated by the second stimulus. The processing circuitry is further configured to associate, in response to the second stimulus, the second extension node with the first active node. The second extension node exhibits at least one of a group consisting of the first functionality, the second functionality, or the second extended functionality.

In some embodiments, the first extension node further exhibits the second functionality.

In some embodiments, the first extension node includes a reference to the first active node.

In some embodiments, based on the first extension node being loaded in the executable graph-based model, the processing circuitry is further configured to load the first active node.

In some embodiments, the processing circuitry is further configured to receive a third stimulus indicative of a third extension operation. The processing circuitry is further configured to identify, from the plurality of active nodes, a second active node. The third extension operation is associated with an extension of a third functionality of the second active node. The processing circuitry is further configured to determine that the extension of the third functionality corresponds to the first extended functionality. The processing circuitry is further configured to associate, in response to the third stimulus, the first extension node with the second active node. The first extension node further exhibits the third functionality.

In some embodiments, for the determination that the extension of the third functionality corresponds to the first extended functionality, the processing circuitry is configured to traverse the executable graph-based model. The processing circuitry is configured to compare the extension of the third functionality with the first extended functionality of the first extension node. The processing circuitry is configured to identify the first extension node based on a match of the extension of the third functionality with the first extended functionality. Based on the identification of the first extension node the extension of the third functionality is determined to be corresponding to the first extended functionality.

In some embodiments, the first extension node includes a reference to at least one of a group consisting of the first active node or the second active node.

In some embodiments, based on the first extension node being loaded in the executable graph-based model, the processing circuitry is further configured to load at least one of a group consisting of the first active node or the second active node.

In some embodiments, the processing circuitry is further configured to receive a fourth stimulus indicative of a first utilization operation associated with the first extension node. The processing circuitry is further configured to identify, in the executable graph-based model, based on the fourth stimulus, the first extension node. The processing circuitry is further configured to determine, based on the identification of the first extension node, the first active node. The first active node is determined based on the association with the first extension node. The processing circuitry is further configured to execute the first utilization operation based on at least one of a group consisting of the first extension node or the first active node.

In some embodiments, the first active node is one of a group consisting of a generic node or a run-time node.

In some embodiments, based on the first active node being the generic node, the first extension node corresponds to a generic extension node. Based on the first active node being the run-time node, the first extension node corresponds to a run-time extension node.

In some embodiments, based on the first extension node being the run-time node, the first extension node includes an extension node template and an extension node instance. The extension node template corresponds to a predefined extension node structure, and the extension node instance corresponds to an implementation of the extension node template.

In some embodiments, the processing circuitry is further configured to receive a fifth stimulus indicative of a second utilization operation associated with the first extension node. The processing circuitry is further configured to determine whether the first extension node is unloaded from the executable graph-based model. The processing circuitry is further configured to load, based on the determination of the first extension node being unloaded from the executable graph-based model, the first extension node in the executable graph-based model. The processing circuitry is further configured to execute the second utilization operation based on at least one of a group consisting of the first extension node or the first active node.

In some embodiments, for loading the first extension node, the processing circuitry is further configured to load the extension node template and the extension node instance. The extension node instance includes a reference to load the extension node template.

In some embodiments, based on the loading of the first extension node, the processing circuitry is further configured to load the first active node.

In some embodiments, based on the first active node being the run-time node, the first active node includes a node template and a node instance. The node template corresponds to a predefined node structure, and the node instance corresponds to an implementation of the node template. Further, for loading the first active node, the processing circuitry is further configured to load the node template and the node instance, of the first active node.

In some embodiments, the executable graph-based model further includes a plurality of overlay nodes, and the processing circuitry is further configured to identify, based on the first stimulus, a first overlay node of the plurality of overlay nodes. The processing circuitry is further configured to associate the first overlay node with the first extension node such that the first overlay node incorporates an additional functionality to the first extension node.

In some embodiments, the first extension node further includes an overlay manager that manages the association of the first extension node with the first overlay node.

In some embodiments, the processing circuitry is further configured to associate the first extension node with a third extension node of the executable graph-based model. The third extension node is associated with a third extended functionality that extends at least one of a group consisting of the first functionality or the first extended functionality. A first extension node-type of the first extension node matches a third extension node-type of the third extension node.

In some embodiments, the processing circuitry is further configured to associate the first extension node with a fourth extension node of the executable graph-based model. The fourth extension node is associated with a third extended functionality that extends at least one of a group consisting of the first functionality or the first extended functionality. A first extension node-type of the first extension node is different from a fourth extension node-type of the fourth extension node.

In some embodiments, the first extension node is one of a group consisting of a stateful node or a stateless node.

In some embodiments, based on the first extension node being the stateful node, the first extended functionality persists in the overlay system based on an unloading of the first extension node.

In some embodiments, based on the first extension node being the stateless node, the first extended functionality ceases to exist in the overlay system based on an unloading of the first extension node.

In some embodiments, a method is provided. The method comprising, receiving, by processing circuitry of an overlay system, a first stimulus indicative of an extension operation. An executable graph-based model is stored in a storage element of the overlay system. The executable graph-based model includes a plurality of active nodes. Each active node of the plurality of active nodes is associated with a corresponding functionality. The method further comprises, identifying, by the processing circuitry, a first active node of the plurality of active nodes. The extension operation is associated with an extension of a first functionality of the first active node. The method further comprises, creating, by the processing circuitry, a first extension node associated with a first extended functionality that extends the first functionality indicated by the first stimulus. The method further comprising, associating, by the processing circuitry, in response to the first stimulus, the first extension node with the first active node. The first extension node exhibits at least one of a group consisting of the first functionality or the first extended functionality.

In some embodiments, the method further comprises, receiving, by the processing circuitry, a second stimulus indicative of a utilization operation associated with the first extension node. The method further comprises, identifying, by the processing circuitry, the first extension node based on the second stimulus. The method further comprises, determining, by the processing circuitry, the first active node based on the identification of the first extension node. The first active node is determined based on the association with the first extension node. The method further comprising, executing, by the processing circuitry, the utilization operation based on at least one of a group consisting of the first extension node or the first active node.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3A is a block diagram that illustrates a standard structure of a generic node within the executable graph-based model, consistent with disclosed embodiments of the present disclosure;

FIG. 3B is a block diagram that illustrates a standard structure of a run-time node within the executable graph-based model, consistent with disclosed embodiments of the present disclosure;

FIG. 4A is a block diagram that illustrates a standard structure of an extension node within the executable graph-based model, consistent with disclosed embodiments of the present disclosure;

FIG. 4B is a block diagram that illustrates a standard structure of a run-time extension node within the executable graph-based model, consistent with disclosed embodiments of the present disclosure;

FIG. 5A is a block diagram that illustrates an executable generic node within the executable graph-based model, consistent with disclosed embodiments of the present disclosure;

FIG. 5B is a block diagram that illustrates an executable run-time node within the executable graph-based model, consistent with disclosed embodiments of the present disclosure;

FIG. 6A is a block diagram that illustrates an executable extension node within the executable graph-based model, consistent with disclosed embodiments of the present disclosure;

FIG. 6B is a block diagram that illustrates an executable run-time extension node within the executable graph-based model, consistent with disclosed embodiments of the present disclosure;

FIG. 7 is a block diagram that illustrates a composition of the executable extension node that enables persistent storage of data and the processing logic associated therewith, consistent with disclosed embodiments of the present disclosure;

FIG. 8 illustrates a graph that depicts implementation of a plurality of extension nodes in conjunction with generic nodes in the executable graph-based model, consistent with disclosed embodiments of the present disclosure;

FIG. 9 illustrates a graph that depicts implementation of the plurality of extension nodes in conjunction with run-time nodes in the executable graph-based model, consistent with disclosed embodiments of the present disclosure;

FIG. 10 illustrates a graph that depicts an employee management system implemented using the executable graph-based model, consistent with disclosed embodiments of the present disclosure;

FIG. 11 shows an example computing system for carrying out methods of the present disclosure, consistent with disclosed embodiments of the present disclosure;

FIG. 12 illustrates a flowchart of a method for execution of an extension operation associated with a first active node in the executable graph-based model, consistent with disclosed embodiments of the present disclosure; and

FIG. 13 illustrates a flowchart of a method for execution of a utilization operation associated with a first extension node, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Graph-based models have become a cornerstone of modern computational frameworks, offering a versatile and efficient approach to representing complex systems. These models enable the representation of entities as nodes and the relationships between them as edges, facilitating a structured yet dynamic visualization of interdependencies. This capability has made graph-based models invaluable in diverse domains such as targeted marketing, scientific research, social network analysis, and recommendation engines.

A key characteristic of graph-based models is the application of rules to define the behavior and accessibility of nodes. Such rules often restrict modification of data associated with nodes of the graph-based models. For example, nodes may be categorized into various types, such as owned nodes and leaf nodes, each with distinct roles and restrictions. Owned nodes are typically linked to specific users, who retain control over their data. While these nodes may be shared with other users, access is limited to specific actions such as viewing or utilizing the data. Modifications to the content of owned nodes by other users are typically restricted, ensuring the data's integrity and consistency.

Leaf nodes, in contrast, represent terminal components within a hierarchical structure of the graph-based models and are designed to be non-inheritable. These nodes often encapsulate static data or functionality, limiting their modifiability and flexibility. The constraints associated with leaf nodes often stem from the need to maintain the structural integrity of the graph-based model, but this also restricts their broader utility within the system.

While such restrictions, both on owned nodes and leaf nodes, serve specific purposes, they also introduce notable limitations in practical applications of the graph-based models. For instance, the inability to modify or extend logic or data within these nodes may hinder the adaptability of the graph-based models to evolving requirements. This may result in various implementation challenges, particularly when these models are applied in dynamic or collaborative environments where flexibility is crucial.

The present disclosure is directed to facilitation of extension nodes in an executable graph-based model of an overlay system. The executable graph-based model is a customized hypergraph with hyper-edges that are realized by way of executable nodes. Each executable node is associated with a particular node-type. For example, an edge node corresponds to a base node with an edge node-type. Nodes (for example, base nodes and executable nodes) are connected with other nodes by way of roles included in an edge node therebetween. In some embodiments, roles are represented by way of nodes of role node-type. A role node between two nodes may be indicative of a context regarding an association therebetween. The executable graph-based model also includes a plurality of overlay nodes that incorporate in-situ features in the overlay system. Each overlay node is associated with one or more nodes (for example, a vertex node, an edge node, or the like) of the executable graph-based model and includes a corresponding processing logic that when executed implements a functionality thereof on the associated nodes. Hence, the processing logic is implemented within the executable graph-based model and is not required to be retrieved from any external system.

The overlay system disclosed herein facilitates the extension nodes in the executable graph-based model. The executable graph-based model may include a plurality of active nodes (for example, a plurality of generic nodes or a plurality of run-time nodes). Each active node may be associated with a corresponding functionality (for example, data or processing logic). The functionalities of the plurality of active nodes may be used for executing various operations within the overlay system. In order to execute such operations, data associated with a set of active nodes of the plurality of active nodes may be required to be modified for adding a new functionality. The new functionality may be a data functionality (i.e., addition of data) and/or an operational functionality (i.e., addition of processing logic).

However, data associated with some of the active nodes of the set of active nodes may not be modified to include the new functionality. In an example, such active nodes may be leaf nodes or owned nodes. Therefore, data associated with such active nodes may be non-modifiable, and hence, the new functionality may not be added to those active nodes based on modification thereof. Active nodes having data that may not be modified may correspond to non-modifiable active nodes. The overlay system disclosed herein allows for addition of a new functionality to a non-modifiable active node (for example, a leaf node or an owned node) by instantiating an extension node in association with the active node. The extension node may be associated with an extended functionality that corresponds to the new functionality to be added to the active node. In other words, the extended functionality may include a data functionality (for example, data) and/or operational functionality (for example, processing logic) to be added to the active node. Further, when associated with the active node, the extension node extends a functionality (for example, data or processing logic) associated with the active node. The extension node may further be able to access the functionality associated with the active node. Therefore, the functionality of the active node and the new functionality may be accessed by way of the extension node associated with the active node. The extension node may be utilized for execution of operations of the overlay system that are to be executed based on the extended functionality and the functionality of the active node associated with the extension node. Thus, the modification of functionalities of various active nodes (for example, the leaf nodes or the owned nodes) may be achieved based on implementation of extension nodes in the overlay system.

Thus, the overlay system disclosed herein allows for implementation of extension nodes in conjunction with active nodes (for example, non-modifiable active nodes). Such implementation of the extension nodes overcomes the limitations of non-modifiable nodes (for example, the leaf nodes or the owned nodes) in the graph-based models. An extension node when associated with an active node allows addition of new functionalities i.e., extended functionalities to the associated active node. Implementation of the extension nodes in the executable graph-based model facilitates enhanced flexibility, scalability, and utility of the overlay system. By allowing modifications to the non-modifiable active nodes, the overlay system enables seamless adaptation of the executable graph-based model to evolving requirements, promoting dynamic updates without compromising data integrity or security. Implementation of the extension nodes in the executable graph-based model, to extend functionalities of active nodes, improves collaboration, as shared nodes could be adjusted to meet diverse user needs while maintaining ownership restrictions. Additionally, it would optimize resource utilization by unlocking the potential of non-inheritable nodes (for example, leaf nodes) based on addition of extended functionality, such as integrating advanced processing logic and/or data. The overlay system disclosed herein exhibits significant simplification in implementation thereof along with a significant reduction in operational complexities. Hence, the overlay system further exhibits significant enhancement in efficiency and scalability of the executable graph-based model across various domains.

### Figure Description

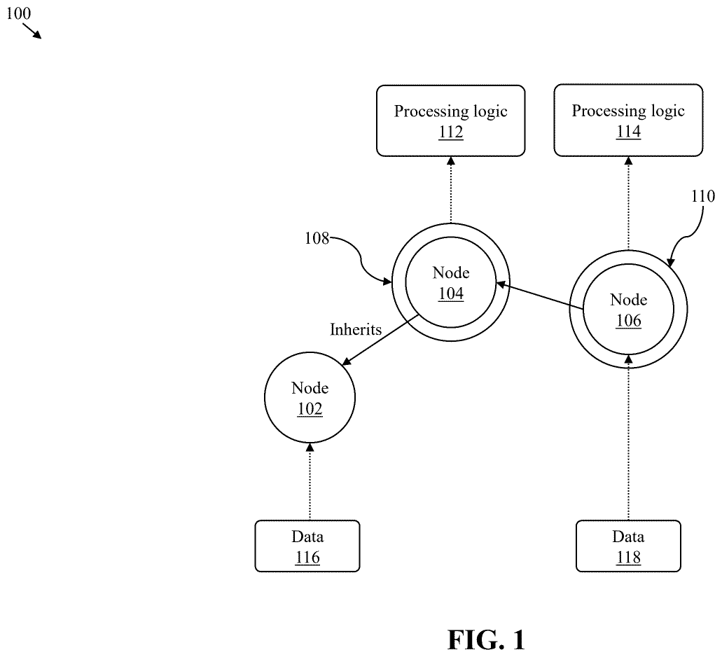

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of active nodes 102-106 which can be functionally extended with processing logic via the use of overlays. Each of the plurality of active nodes 102-106 may also be referred to as a node. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114 which are associated with the overlay nodes 108 and 110, respectively. At run-time, data, such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

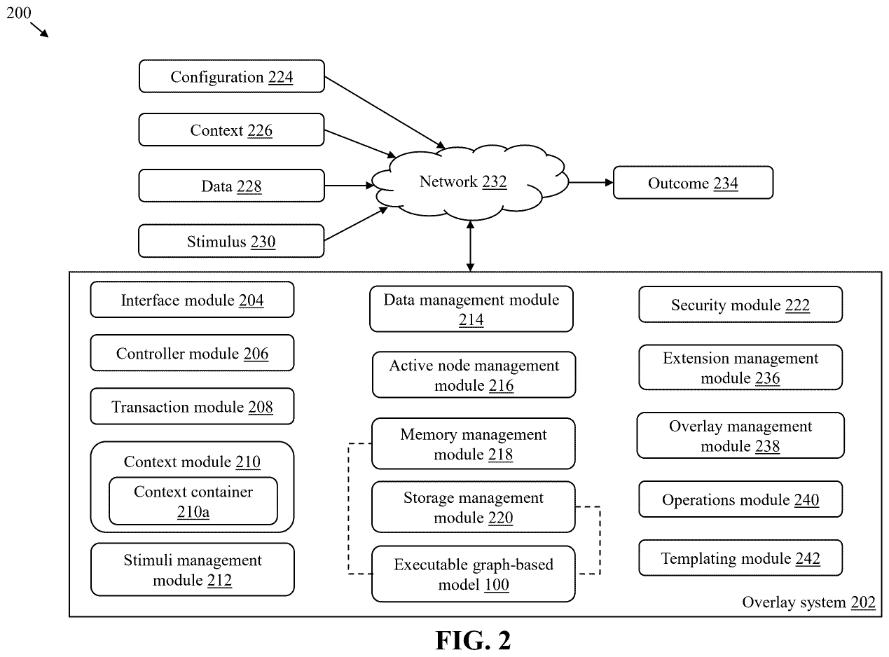

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a data management module 214, an active node management module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure includes an extension management module 236, an overlay management module 238, an operations module 240, and a templating module 242. In some embodiments, all the modules of the overlay system 202 except for the executable graph-based model 100 may collectively form processing circuitry that facilitates operations associated with a plurality of active nodes of the executable graph-based model 100. The plurality of active nodes may include generic nodes and run-time nodes.

A generic node may refer to a node, in the executable graph-based model 100, with an edge node-type, a role node-type, an overlay node-type, or a vertex node-type. A generic node with the vertex node-type is coupled to another generic node with the vertex node-type by way of a node with the edge node-type indicative of a role of the generic node. A run-time node may include a node template and node instance. The node template may be a predefined node structure and the node instance may be an implementation of the predefined node structure. The run-time node may have an edge node-type, a role node-type, an overlay node-type, or a vertex node-type. A run-time node with the vertex node-type is coupled to other run-time node with the vertex node-type by way of a run-time node with the edge node-type indicative of a role of the run-time node. Each active node may be associated with a functionality (namely, an initial functionality). The functionality may correspond to data and/or processing logic.

The overlay system 202 may include suitable logic, circuitry, interfaces, and/or code, executable by the circuitry, that may be configured to facilitate one or more operations associated with the active nodes in the executable graph-based model 100.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that are required for processing of the stimulus 230 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 includes a context container 210a that includes a set of defined contexts. Each defined context of the set of defined contexts pertains to a context that is associated with one or more operations for facilitating application and management of the plurality of nodes (for example, the active nodes) in the overlay system 202. That is to say that, one or more contexts of the set of defined contexts are indicative of the one or more operations to be executed by way of one or more active nodes in the overlay system 202. The one or more operations are executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a signal, a textual, audio, or visual input. The externally triggered stimulus 230 may be associated with the intent of a user to execute an operation indicated by the stimulus 230. The operation is executed in accordance with information included in the context 226 associated with the stimulus 230.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus. In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as the stimulus 230) results in the generation, communication, or processing of data that further results in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 240 of the overlay system 202.

The data management module 214 may include suitable logic, circuitry, interfaces, and/or code, executable by the circuitry, configured to manage all data or information within the overlay system 202 (e.g., the data 228) for a given application. Operations performed by the data management module 214 include data loading, data unloading, data modeling, and data processing. The data management module 214 is communicatively coupled (e.g., connected either directly or indirectly) to one or more other modules within the overlay system 202 to complete some or all of these operations. For example, data storage is handled by the data management module 214 in conjunction with the storage management module 220.

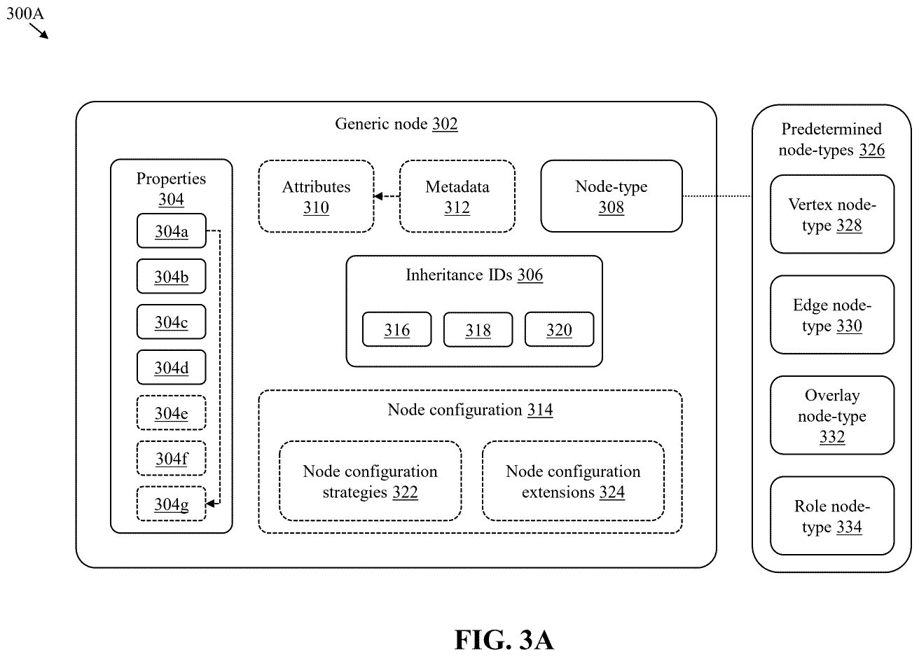

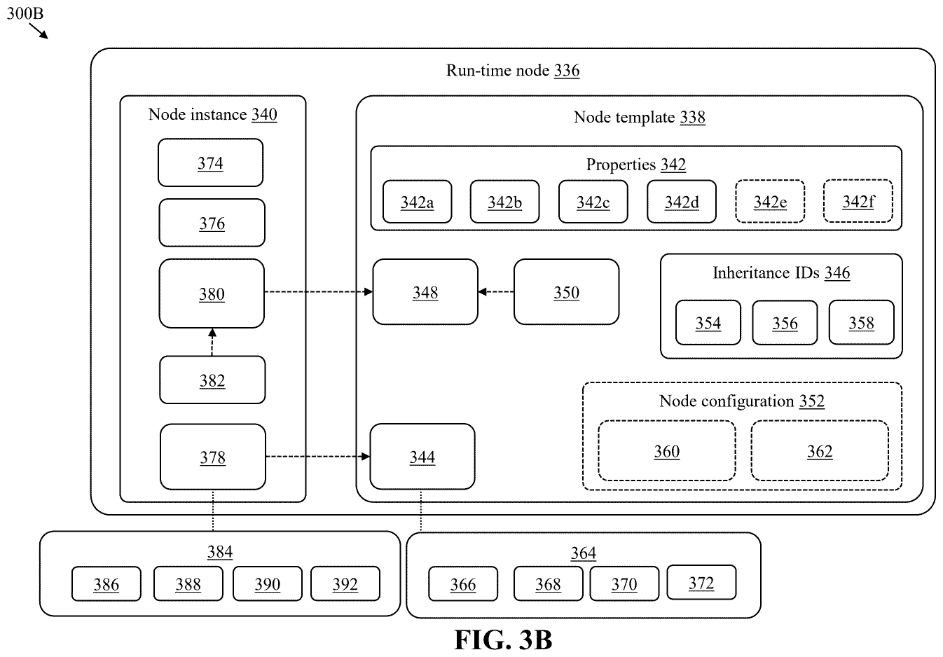

The active node management module 216 may include suitable logic, circuitry, interfaces, and/or code, executable by the circuitry, configured to manage, design, and implement the plurality of active nodes in the overlay system 202. The active nodes may include the generic nodes and the run-time nodes. Further, each active node may have a vertex node-type, an edge node-type, a role node-type, or an overlay node-type (described in conjunction with FIGS. 3A and 3B). Further, each active node may have a functionality associated therewith. The active node management module 216 is further configured to facilitate operations associated with execution of one or more transactions using the active nodes.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’is used interchangeably with the term ‘storage element’.

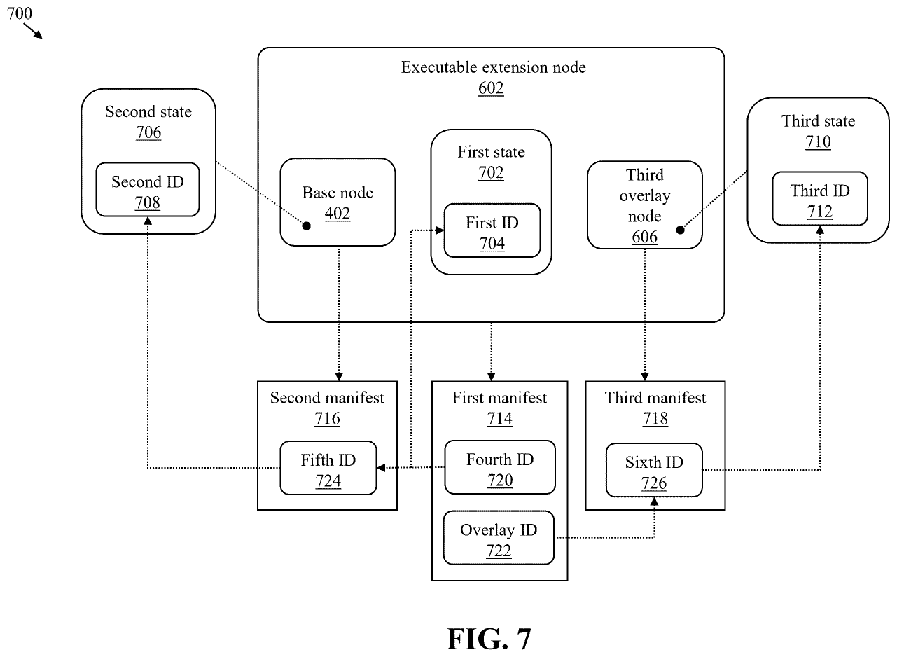

As described, storage, loading, and unloading of the executable graph-based model 100 or one or more components thereof is facilitated by the memory management module 218 and the storage management module 220. The memory management module 218 and the storage management module 220 may facilitate such operations by interacting with the storage device that stores the executable graph-based model 100. The overlay system 202 further includes a plurality of manifest storages. The manifest storages are used by the memory management module 218 and the storage management module 220 to facilitate storage of manifest states (including manifest template states and manifest instance states) of active nodes. The storage element may include a primary storage and a secondary storage. The primary storage may store the executable graph-based model 100 and may also store nodes that are loaded in the executable graph-based model 100. The secondary storage may store node states, manifests, and manifest states associated with nodes that are unloaded from the executable graph-based model 100. Storage and retrieval of active nodes are described in detail in conjunction with FIG. 7.

The security module 222 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the data associated with the overlay system 202 contains Personally Identifiable Information (PII) or Protected Health Information (PHI), the security module 222 can implement one or more layers of data protection to ensure that the PII or PHI are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the overlay management module 238 and the extension management module 236 for managing and executing security-based overlays and security-based operational functionalities associated with one or more extension nodes.

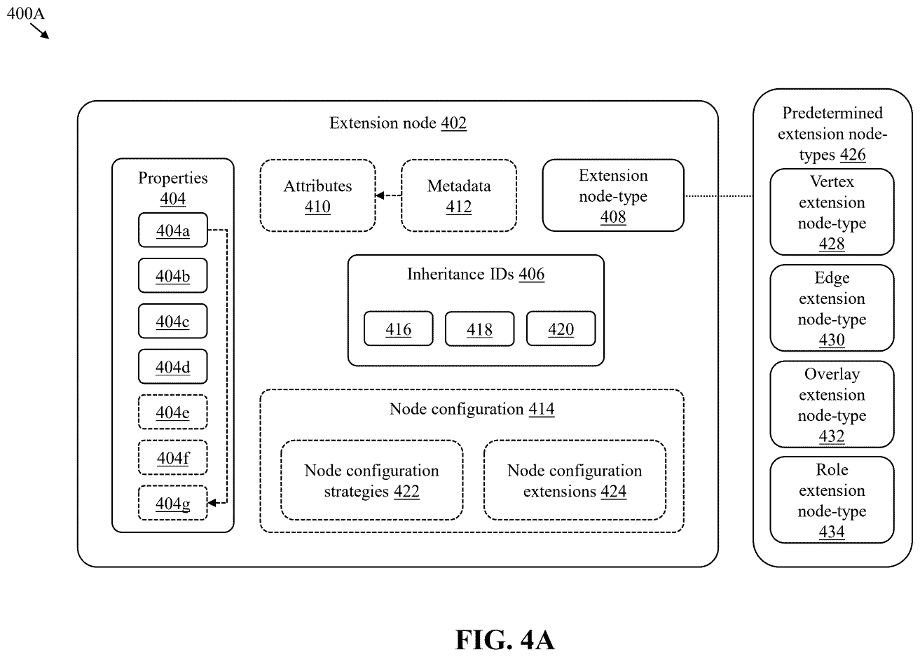

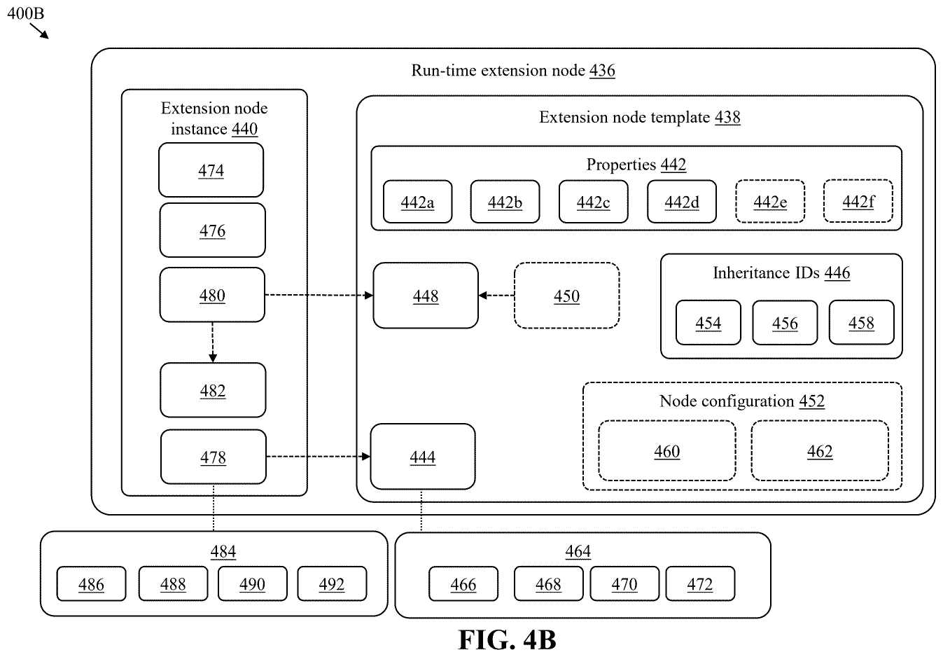

An extension node, when instantiated in association with an active node (for example, the generic node and the run-time node), extends a functionality (i.e., an initial functionality) of the active node. Hereinafter, the functionality of the active node that may have to be extended is referred to as an initial functionality. The extension node may exhibit an extended functionality that may correspond to a functionality to be added to the initial functionality for extension thereof. Based on the association with the active node, the extension node may also exhibit the initial functionality (for example, data or processing logic) of the active node. The extended functionality may correspond to data or processing logic to be added to the active node to extend or modify the initial functionality of the active node. The extended functionality may be a data functionality or an operational functionality. The data functionality may refer to a dataset being added to the initial functionality of the active node whereas the operation functionality may refer to processing logic being added to the initial functionality of the active node. The extension node may exhibit the initial functionality of the active node associated therewith as well as the extended functionality. Further, an extension node may have a vertex extension node-type, an edge extension node-type, a role extension node-type, or an overlay extension node-type (described in conjunction with FIGS. 4A and 4B). In some embodiments, the extension node may not have any node-type. The executable graph-based model 100 may include a plurality of extension nodes that enable modification of data and/or processing logic associated with active nodes. Such active nodes may include non-modifiable data and/or processing logic. Throughout the description, an active node with non-modifiable data and/or processing logic is referred to as a non-modifiable active node or a non-modifiable node. Notably, non-modifiable data and/or processing logic correspond to data and/or processing logic, respectively, which cannot be altered, edited, or restructured once defined within the overlay system 202.

The extension management module 236 may include suitable logic, circuitry, interfaces, and/or code, executable by the circuitry, configured to execute one or more operations for creation, updates, deletion, management, design, and implementation of the plurality of extension nodes in the overlay system 202. The extension management module 236 may be further configured to manage association of each extension node of the plurality of extension nodes with one or more active nodes of the plurality of active nodes. The one or more active nodes associated with each extension node may be referred to as source nodes for the extension node. The extension management module 236 may be further configured to facilitate operations associated with execution of one or more transactions using the extension nodes in the overlay system 202.

The overlay management module 238 may include suitable logic, circuitry, interfaces, and/or code, executable by the circuitry, configured to manage all overlays within the overlay system 202. The overlays may be generic overlays, generic run-time overlays, extension overlays, or run-time extension overlays. Extension overlays are associated with generic nodes and/or extension nodes and extend functionality of the generic nodes and/or extension nodes. Description of an extension overlay may be same as a generic overlay node. Additionally, the extension overlay may extend functionality of an associated generic node. Similarly, description of a run-time extension overlay node may be same as a run-time overlay node. Additionally, the run-time extension overlay may extend functionality of an associated run-time node.

Generic overlays are associated with generic nodes and/or extension nodes and extend functionality of the generic nodes and/or extension nodes. A run-time extension overlay node is same as the extension overlay node. In addition, the run-time extension overlay node may include a node template and a node instance. Operations performed by the overlay management module 238 may include overlay storage management, overlay structure modeling, overlay logic creation and execution, and overlay loading and unloading (within the executable graph-based model 100). The overlay management module 238 is communicatively coupled (e.g., connected either directly or indirectly) to one or more other modules within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The operations module 240 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like).

The templating module 242 may include suitable logic, circuitry, interfaces, and/or code, executable by the circuitry, configured to enable the overlay system 202 to implement a templated version of one or more nodes (for example, the run-time nodes, the run-time extension nodes, or the like) of the executable graph-based model 100. The templating module 242 may be configured to create one or more predefined templates in the executable graph-based model 100. The templating module 242 may be further configured to generate one or more node instances of the predefined node templates for the implementation of the templated version of the executable graph-based model 100. Notably, the templating module 242 ensures ontology integrity by enforcing structure and rules of a template when generating instances of the template at run-time. Ontology integrity refers to consistency, accuracy, and correctness of an ontology. Thus, the templating module 242 ensures that the consistency, accuracy, and correctness of the ontology of the executable graph-based model 100 are maintained while generating the instances of the template at run-time. The templating module 242 may be communicatively coupled (i.e., connected either directly or indirectly) to one or more nodes and/or one or more overlays within the executable graph-based model 100.

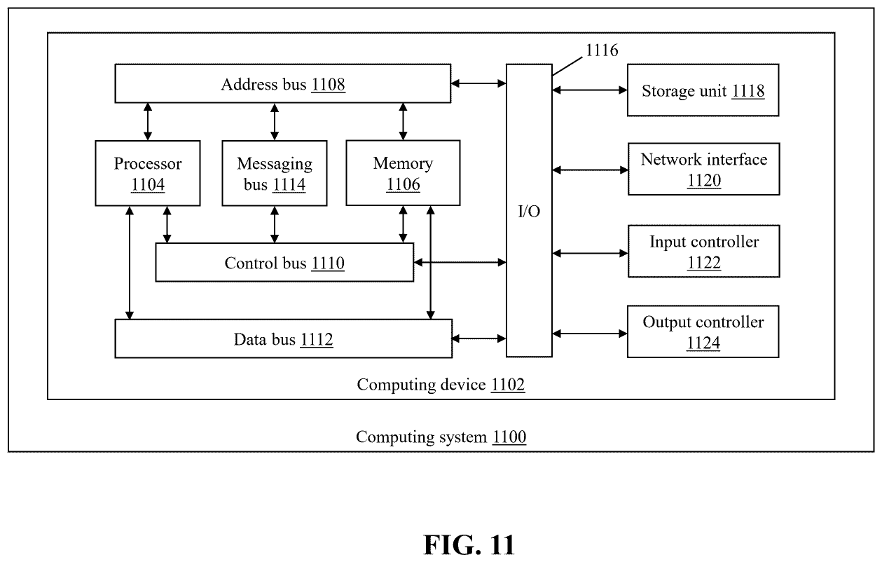

Beneficially, various features of the overlay system 202 support the processing circuitry and a computing system (shown in FIG. 11) implementing the overlay system 202 in significantly enhancing its performance. The significant enhancement in performance may include significantly increased throughput and efficiency, as well as significantly reduced cost complexity, processing complexity, time complexity, latency, waiting time, turnaround time, or the like.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model, specifically, the concept of a node. Unlike conventional graph-based systems, all elements (e.g., data, overlays, etc.) within the executable graph-based model 100 are implemented as nodes. As will become clear, this allows executable graph-based models to be flexible, extensible, and highly configurable.

FIG. 3A is a block diagram 300A that illustrates a standard structure of a generic node 302 within the executable graph-based model 100, consistent with disclosed embodiments of the present disclosure. Referring to FIG. 3A, the generic node 302 corresponds to a generic node of the executable graph-based model 100. The generic node 302 further corresponds to the core structure of the executable graph-based model 100 and forms the foundational building block for all data and processing logic within the executable graph-based model 100. The generic node 302 includes properties 304, inheritance IDs 306, and a node-type 308. The generic node 302 optionally includes one or more attributes 310, metadata 312 associated with the attributes 310, and a node configuration 314.

The properties 304 of the generic node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the generic node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the generic node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the generic node 302 is incremented when the generic node 302 undergoes transactional change. This allows the historical changes between versions of the generic node 302 to be tracked by modules or overlays within the overlay system 202. The namespace 304c of the generic node 302, along with the name 304d of the generic node 302, is used to help organize nodes within the executable graph-based model 100. That is, the generic node 302 is assigned a unique name 304d within the namespace 304c such that the name 304d of the generic node 302 need not be unique within the entire executable graph-based model 100, only within the context of the namespace 304c to which the generic node 302 is assigned. The generic node 302 optionally includes one or more icons 304e which are used to provide a visual representation of the generic node 302 when visualized via a user interface. The one or more icons 304e can include icons at different resolutions and display contexts such that the visualization of the generic node 302 is adapted to different display settings and contexts. The generic node 302 also optionally includes one or more labels 304f which are used to override the name 304d when the generic node 302 is rendered or visualized.

The generic node 302 supports the concept of inheritance of data and processing logic associated with any other node of the executable graph-based model 100 that is inherited by the generic node 302. This allows the behavior and functionality of the generic node 302 to be extended or derived from the inherited node of the executable graph-based model 100. The inheritance IDs 306 of the generic node 302 indicate the inheritance-based information, which may apply to the generic node 302. The inheritance IDs 306 comprise a set of Boolean flags that identify the inheritance structure of the generic node 302. The abstract flag 316 allows the generic node 302 to support the construct of abstraction. When the abstract flag 316 takes a value ‘true’, the generic node 302 is flagged as abstract that is to say that it cannot be instantiated or created within an executable graph-based model (e.g., the executable graph-based model 100). Thus, in an instance when the generic node 302 has the abstract flag 316 set to ‘true’, the generic node 302 may only form the foundation of other nodes that inherit therefrom. By default, the abstract flag 316 of the generic node 302 is set to ‘false’. The leaf flag 318 is used to indicate whether any other node may inherit from the generic node 302. If the leaf flag 318 is set to ‘true’, no other node may inherit from the generic node 302 (but unlike an abstract node, a node with the leaf flag 318 set may be instantiated and created within the executable graph-based model 100). The root flag 320 is used to indicate whether the generic node 302 inherits from any other node. If the root flag 320 is set to ‘true’, the generic node 302 does not inherit from any other node. The generic node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’whilst the leaf flag 318 is set to ‘true’).

As stated above, all elements of the executable graph-based model 100 are defined as nodes. This functionality is in part realized due to the use of a node-type. The node-type 308 of the generic node 302 is used to extend the functionality of the generic node 302. All nodes within the executable graph-based model 100 comprise a node-type that defines additional data structures and implements additional executable functionality. A node-type thus includes data structures and functionality that are common across all nodes that share that node-type. Therefore, composition of a node with a node-type improves extensibility by allowing the generation of specialized node functionalities for specific application areas. Such extensibility is not present in prior art graph-based models. As illustrated in FIG. 3A, the generic node 302 and the node-type 308 are one logical unit that is not separated in the context of an executing system at run-time (e.g., in the context of execution of an executable graph-based model).

FIG. 3A further shows the plurality of predetermined node-types 326 which provides a non-exhaustive list of node-types for the node-type 308 associated with the generic node 302. The plurality of predetermined node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes and thus the edge node-type 330 constructs associations and connections between nodes (for example, objects or ‘things’) within the executable graph-based model 100. The edge node-type 330 is not restricted to the number of nodes that can be associated or connected by a node having the edge node-type 330. The data structures and functionality of the edge node-type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node-types 326 further includes an overlay node-type 332 and a role node-type 334. As will be described in more detail below, a node with the overlay node-type 332 is used to extend the functionality of a node, such as the generic node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node.

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited.

The one or more attributes 310 correspond to the data associated with the generic node 302 (e.g., the data represented by the generic node 302 within the executable graph-based model 100 as handled by the data management module 214). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, or a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the generic node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the generic node 302 further includes the metadata 312 (e.g., data stored as a name, a confidentiality indicator for indicating data as sensitive and/or confidential, an average processing time required for processing data, or the like) which is associated with either the generic node 302 or an attribute (for example, the one or more attributes 310) of the generic node 302. An attribute within the one or more attributes 310 may either have an independent state or a shared state. That is to say, an attribute may be a value-shared attribute or a non-value-shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, updating the data (e.g., the value) of this shared attribute will be reflected across both nodes.

The node configuration 314 provides a high degree of configurations for the different elements of the generic node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the generic node 302, which creates message source IDs. A further example of a concrete node configuration strategies 322 is a versioning strategy, associated with the configuration of the version ID 304b of the generic node 302, which supports major and minor versioning (depending on the type of transactional change incurred by the generic node 302). The versioning strategy may be adapted to a native filing system of a user device hosting the overlay system 202 or a third-party data storage (for example, Snowflake®, or the like) associated with the overlay system 202. All attribute configurations examples of node configuration extensions 324.

FIG. 3B is a block diagram 300B that illustrates a standard structure of a run-time node 336 within the executable graph-based model 100, consistent with disclosed embodiments of the present disclosure. Referring to FIG. 3B, the run-time node 336 corresponds to the core structure of the executable graph-based model 100 and forms the foundational building block for all data and processing logic within the executable graph-based model 100. The run-time node 336 is shown to include a node template 338 and a node instance 340. The node instance 340 is generated according to the node template 338. The node template 338 forms a data structure for the node instance 340. In other words, the node instance 340 is an implementation of the node template 338. The run-time node 336 shown in FIG. 3B is a compositional structure that is generated and executed, at run-time as part of the executable graph-based model 100. In other words, the node template 338 is defined as ‘offline’ and the node instance 340 and the run-time node 336 are run-time structures that are dynamically generated during execution of the executable graph-based model 100.

The node template 338 comprises a predetermined node structure. Further, the node template 338 defines one or more rules that govern the generation of the node instance 340. The node instance 340 is an implementation of the predefined node structure of the node template 338. In other words, the node instance 340 is generated based on the predetermined node structure and the one or more rules of the node template 338. The node template 338 cannot be modified during the execution but may be modified during offline mode or at rest. During execution, only the node instance 340 of the run-time node 336 may be modified.

The node template 338 includes properties 342, a node-type template 344, inheritance IDs 346, and a set of attribute templates 348. The node template 338 may optionally include metadata 350 and a node configuration 352. The properties 342 of the node template 338 include a unique identifier (ID) 342a, a version ID 342b, a namespace 342c, a name 342d, and optionally include one or more icons 342e and a set of labels 342f. The inheritance IDs 346 comprise an abstract flag 354, a leaf flag 356, and a root flag 358. The node configuration 352 optionally comprises one or more node configuration strategies 360 and/or one or more node configuration extensions 362. The node configuration strategies 360 may have a description similar to the description of the node configuration strategies 322. The node configuration extensions 362 may have a description similar to the description of the node configuration extensions 324.

FIG. 3B further shows a plurality of predetermined node-type templates 364 of the node-type template 344. The plurality of predetermined node-type templates 364 includes a vertex node-type template 366, an edge node-type template 368, an overlay node-type template 370, and a role node-type template 372. Further, the node instance 340 includes a unique ID 374, a version ID 376, a node-type instance 378, and a set of attribute instances 380. The node instance 340 may optionally include metadata 382. FIG. 3B further shows a plurality of predetermined node-type instances 384 of the node-type instance 378. The plurality of predetermined node-type instances 384 include a vertex node-type instance 386, an edge node-type instance 388, an overlay node-type instance 390, and a role node-type instance 392.

The unique ID 342a is unique for each node template within the executable graph-based model 100. Similarly, the unique ID 374 is unique for each node instance within the executable graph-based model 100. The unique ID 342a and the unique ID 374 are used to register, manage, and reference the node template 338 and the node instance 340, respectively, within the overlay system 202. The version ID 342b of the node template 338 is incremented when the node template 338 undergoes transactional change. Similarly, the version ID 376 of the node instance 340 is incremented when the node instance 340 undergoes transactional change. The namespace 342c of the node template 338, along with the name 342d of the node template 338, is used to help organize node templates within the executable graph-based model 100. That is, the node template 338 is assigned a unique name 342d within the namespace 342c such that the name 342d of the node template 338 need not be unique within the entire executable graph-based model 100, only within the context of the namespace 342c to which the node template 338 is assigned. The node template 338 optionally comprises one or more icons 342e which are used to provide a visual representation of the node template 338. The one or more icons 342e can include icons at different resolutions and display contexts such that the visualization of the node is adapted to different display contexts and settings. The node template 338 also optionally comprises the set of labels 342f which are used to override the name 342d when the node template 338 is rendered or visualized.

The node template 338 supports the software development feature of multiple inheritance by maintaining references (not shown) to zero or more other node templates, which then act as the base of the node template 338. This allows the behavior and functionality of a node template to be extended or derived from one or more other node templates within an executable graph-based model (such as the executable graph-based model 100). The node instance 340 likewise supports multiple inheritance because it is an instance representation of the node template 338. The multiple inheritance structure of the node instance 340 is, however, limited to the corresponding instance realization of the multiple inheritance structure defined by the node template 338, i.e., one node instance 340 is created and managed for each node template 338 defined in the inheritance hierarchy for a node instance of a node template.

The inheritance IDs 346 of the node template 338 provide an indication of the inheritance-based information, which is applicable, or can be applicable, to the node template 338. The inheritance IDs 346 have a description that is similar to the inheritance IDs 306. The abstract flag 354 has a description that is similar to the abstract flag 316, the leaf flag 356 has a description that is similar to the leaf flag 318, and the root flag 358 has a description that is similar to the root flag 320.

In embodiments, when an active node may be a run-time node, all elements within the executable graph-based model 100 are defined as node templates or node instances. The functionality of the node template 338 and the node instance 340 are realized due to the use of the node-type template 344 and the node-type instance 378. The node-type template 344 of the node template 338 is used to extend the functionality of the node template 338 by defining the standard set of capabilities, including data and associated behavior.

The vertex node-type template 366 (also referred to as a data node-type) includes a template of common data structures and functionality related to the ‘things’ modeled in the graph (e.g., the data). The vertex node-type instance 386 includes the common data structures and functionality related to the ‘things’ modeled in the graph based on the vertex node-type template 366. The edge node-type template 368 includes a template of common data structures and functionality related to joining two or more nodes. A node instance having the edge node-type instance 388 may connect two or more nodes and thus the edge node-type instance 388 constructs associations and connections between nodes (for example objects or ‘things’) within the executable graph-based model 100. The edge node-type instance 388 is not restricted to the number of nodes that can be associated or connected by a node having the edge node-type instance 388. The data structures and functionality of the edge node-type instance 388 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The role node-type template 372 is used to define structure, conditions, or the like for establishing a connective relationship between two node instances or node templates. Similarly, the role node-type instance 392 is used to define a connective relationship between two node instances. The overlay node-type template 370 is used to extend the functionality of a node template (e.g., the node template 338) to incorporate processing logic. Similarly, the overlay node-type instance 390 is used to extend the functionality of a node instance (e.g., the node instance 340) to incorporate processing logic.

The set of attribute templates 348 corresponds to the data defined by the node template 338. For example, the set of attribute templates 348 may define the names and value types (e.g., integer, string, float, etc.) of one or more attributes but not the values of these attributes. The values of the set of attribute templates 348 may be defined by the set of attribute instances 380 of the node instance 340 through one or more values or instance values. For example, the node template 338 may define a string attribute ‘surname’ and the corresponding node instance 340 may assign the instance value ‘Bell-Richards’ to this string attribute. Each attribute instance of the set of attribute instances 380 is associated with an attribute template of the set of attribute templates 348. The node template 338 may define one or more default values for the set of attribute templates 348. The default values correspond to the values that the attributes take if no value is assigned. The metadata 350 (e.g., data stored as a name, a value type, and a value triplet) is associated with either the node template 338 or one or more of the set of attribute templates 348 of the node template 338. Similarly, the node instance 340 also optionally comprises the metadata 350 (e.g., data stored as a name, a value type, and a value triplet) which is associated with either the node instance 340 or one or more of the set of attribute instances 380.

The node configuration 352 provides a high degree of configurability for the different elements of a node template and/or a node instance. An example of a concrete node configuration strategy is an ID strategy, associated with the configuration of the unique ID 342a of the node template 338. A further example of a concrete node configuration strategy is a versioning strategy, associated with the configuration of the version ID 342b of the node template 338 which supports major and minor versioning (depending on the type of transactional change incurred). The versioning strategy may be adapted to a native filing system of a user device hosting the overlay system 202 or a third-party data storage (for example, Snowflake®, or the like) associated with the overlay system 202.

It will be apparent to a person skilled in the art that each node of the executable graph-based model 100 has a generic structure that is similar to the generic node 302 of FIG. 3A or the run-time node 336 of FIG. 3B.

FIG. 4A is a block diagram 400A that illustrates a standard structure of an extension node 402 within the executable graph-based model 100, consistent with disclosed embodiments of the present disclosure. Referring to FIG. 4A, the extension node 402 corresponds to the core structure of the executable graph-based model 100 and forms the foundational building block for various data and processing logics within the executable graph-based model 100. The extension node 402 includes properties 404, inheritance IDs 406, an extension node-type 408, attributes 410, metadata 412, and a node configuration 414. The extension node 402 may be associated with the generic node 302. The extension node 402 being associated with the generic node 302 may form a part of a logical structure of the generic node 302. Based on the association between the generic node 302 and the extension node 402, the extension node 402 may extend the data functionality and/or operational functionality associated with the generic node 302.

The properties 404 include a unique ID 404a, a version ID 404b, a namespace 404c, a name 404d, one or more icons 404e, one or more labels 404f, and one or more alternative IDs 404g. The properties 404 of the extension node 402 has a description similar to the description of the properties 304 of the generic node 302. In other words, the unique ID 404a, the version ID 404b, the namespace 404c, the name 404d, the one or more icons 404e, the one or more labels 404f, and the one or more alternative IDs 404g have descriptions similar to the description of the unique ID 304a, the version ID 304b, the namespace 304c, the name 304d, the one or more icons 304e, the one or more labels 304f, and the one or more alternative IDs 304g, respectively, of the generic node 302.

The inheritance IDs 406 of the extension node 402 include an abstract flag 416, a leaf flag 418, and a root flag 420. The inheritance IDs 406 of the extension node 402 has a description similar to the description of the inheritance IDs 306 of the generic node 302. In other words, the abstract flag 416, the leaf flag 418, and the root flag 420 have descriptions similar to the description of the abstract flag 316, the leaf flag 318, and the root flag 320, respectively, of the generic node 302.

The attributes 410 of the extension node 402 has a description similar to the description of the attributes 310 of the generic node 302. In addition, the metadata 412 has a description similar to the description of the metadata 312 of the generic node 302.

The node configuration 414 of the extension node 402 includes node configuration strategies 422 and node configuration extensions 424. The node configuration 414 is same as the node configuration 314 of the generic node 302. In other words, the node configuration strategies 422 and the node configuration extensions 424 of the extension node 402 are same as the node configuration strategies 322 and the node configuration extensions 324, respectively, of the generic node 302.

The extension node 402 may have the extension node-type 408 which may be one of predetermined node-types 426. The extension node-type 408 may have a description similar to the description of the node-type 308. The predetermined node-types 426 of the extension node 402 may include a vertex extension node-type 428, an edge extension node-type 430, an overlay extension node-type 432, and a role extension node-type 434. The vertex extension node-type 428 is same as the vertex node-type 328. The edge extension node-type 430 is same as the edge node-type 330. The overlay extension node-type 432 is same as the overlay node-type 332, whereas the role extension node-type 434 is same as the role node-type 334.

Although it is described that the extension node 402 may have the extension node-type 408, however, in some embodiments, the extension node 402 may not have the extension node-type 408. In other words, the extension node 402 may not have an associated extension node-type.

FIG. 4B is a block diagram 400B that illustrates a standard structure of a run-time extension node 436 within the executable graph-based model 100, consistent with disclosed embodiments of the present disclosure. Referring to FIG. 4B, the run-time extension node 436 corresponds to the core structure of the executable graph-based model 100 and forms the foundational building block for all data and processing logic within the executable graph-based model 100.

The run-time extension node 436 is shown to include an extension node template 438 and an extension node instance 440. The extension node instance 440 is generated according to the extension node template 438. The extension node template 438 forms a data structure for the extension node instance 440. Notably, the extension node template 438 corresponds to a predefined extension node structure. The extension node instance 440 may be an implementation of the extension node template 438. The extension node instance 440 may include a reference (for example, a point, a storage location, or the like) associated with the extension node template 438.

The run-time extension node 436 shown in FIG. 4B is a compositional structure that is generated and executed, at run-time as part of the executable graph-based model 100. In other words, the extension node template 438 is defined as ‘offline’ and the extension node instance 440 and the run-time extension node 436 may be run-time structures that may be dynamically generated during execution of the executable graph-based model 100.

The extension node template 438 has a description similar to the description of the node template 338 described in conjunction with FIG. 3B whereas the extension node instance 440 has a description similar to the description of the node instance 340 described in conjunction with FIG. 3B.

The extension node template 438 may include properties 442, a node-type template 444, inheritance IDs 446, and a set of attribute templates 448. The extension node template 438 may optionally include metadata 450 and node configuration 452. The properties 442 of the extension node template 438 include a unique identifier (ID) 442a, a version ID 442b, a namespace 442c, a name 442d, and optionally include one or more icons 442e and a set of labels 442f. The inheritance IDs 446 comprise an abstract flag 454, a leaf flag 456, and a root flag 458. The node configuration 452 optionally comprises one or more node configuration strategies 460 and/or one or more node configuration extensions 462. FIG. 4B further shows a plurality of predetermined extension node-type templates 464. The plurality of predetermined extension node-type templates 464 may include a vertex extension node-type template 466, an edge extension node-type template 468, an overlay extension node-type template 470, and a role extension node-type template 472.

The extension node instance 440 may include a unique ID 474, a version ID 476, node-type instances 478, and a set of attribute instances 480. The extension node instance 440 may optionally include metadata 482. FIG. 4B further shows a plurality of predetermined extension node-type instances 484. The plurality of predetermined extension node-type instances 484 include a vertex extension node-type instance 486, an edge extension node-type instance 488, an overlay extension node-type instance 490, and a role extension node-type instance 492.

The properties 442 of the extension node template 438 may have a description that is similar to the description of the properties 342 described in conjunction with FIG. 3B. In other words, the unique ID 442a, the version ID 442b, the namespace 442c, the name 442d, the icons 442e, and the set of labels 442f may have descriptions that may be similar to descriptions of the unique ID 342a, the version ID 342b, the namespace 342c, the name 342d, the icons 342e, and the set of labels 342f, respectively, shown in FIG. 3B.

The inheritance IDs 446 of the extension node template 438 has a description that is similar to the inheritance IDs 346 of the node template 338. In other words, the abstract flag 454, the leaf flag 456, and the root flag 458 may have descriptions that may be similar to the abstract flag 354, the leaf flag 356, and the root flag 358, respectively, shown in FIG. 3B.

In some embodiments, the functionality of the extension node template 438 and the extension node instance 440 may be realized due to the use of the extension node-type templates 464 and the extension node-type instances 484, respectively. The extension node-type templates 464 has a description that is similar to the node-type template 344 of the node template 338 shown in FIG. 3B. In other words, the vertex extension node-type template 466 has a description similar to the description of the vertex node-type template 366 shown in FIG. 3B, the edge extension node-type template 468 has a description similar to the description of edge node-type template 368 shown in FIG. 3B, the overlay extension node-type template 470 has a description similar to the description of the overlay node-type template 370 as shown in FIG. 3B. Similarly, the edge extension node-type instance 488 has a description similar to the description of the edge node-type instance 388 shown in FIG. 3B whereas the overlay extension node-type instance 490 has a description similar to the description of the overlay node-type instance 390 shown in FIG. 3B. The extension node-type templates 464 also may include the role extension node-type template 472. The role extension node-type template 472 may include a template of roles and associations of the extension node template 438. The role extension node-type template 472 may be used to associate the extension node template 438 with one or more other node templates. The role extension node-type template 472 may include roles and role attributes and descriptions for the roles by way of which the extension node template 438 may be associated with one or more other node templates. The role extension node-type instance 492 may be used to associate the extension node instance 440 with one or more other node instances.

The set of attribute templates 448 has a description that is similar to the description of the set of attribute templates 348 described in conjunction with FIG. 3B. The metadata 450 has a description that is similar to the metadata 350 depicted in FIG. 3B. Similarly, the set of attribute instances 480 has a description that is similar to the set of attribute instances 380 of FIG. 3B and the metadata 482 have a description that is similar to the metadata 382 of FIG. 3B.

The node configuration 452 has a description that may be similar to the node configuration 352 of FIG. 3B. In other words, the description of the node configuration strategies 460 may be similar to the description of the node configuration strategies 360, and the description of the node configuration extensions 462 is similar to the description of the node configuration extensions 362.

The unique ID 474 may have a description similar to the unique ID 374 described in conjunction with FIG. 3B. The version ID 476 may have a description similar to the version ID 376 described in conjunction with FIG. 3B.

The plurality of predetermined extension node-type instances 484 may have a description similar to the plurality of predetermined node-type instances 384. The vertex extension node-type instance 486 may have a description similar to the vertex node-type instance 386. The edge extension node-type instance 488 may have a description similar to the edge node-type instance 388. The overlay extension node-type instance 490 may have a description similar to the overlay node-type instance 390. The role extension node-type instance 492 may have a description similar to the role node-type instance 392.

Throughout the description, an overlay node of the executable graph-based model 100 that is a run-time extension node is referred to as a run-time extension overlay node. A node (for example, an active node, an extension node, or the like) when associated with an overlay node is referred to as an executable node and may exhibit data as well as processing capability at run-time.

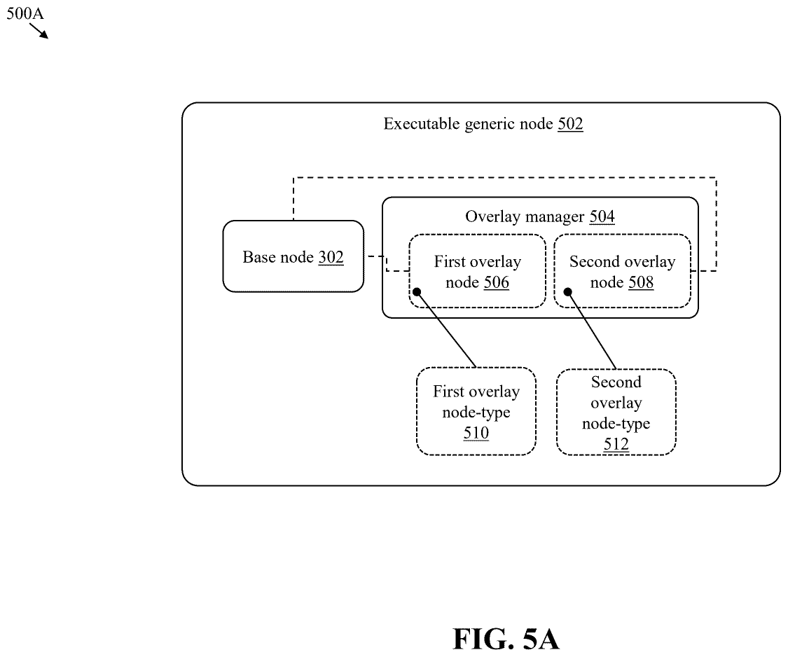

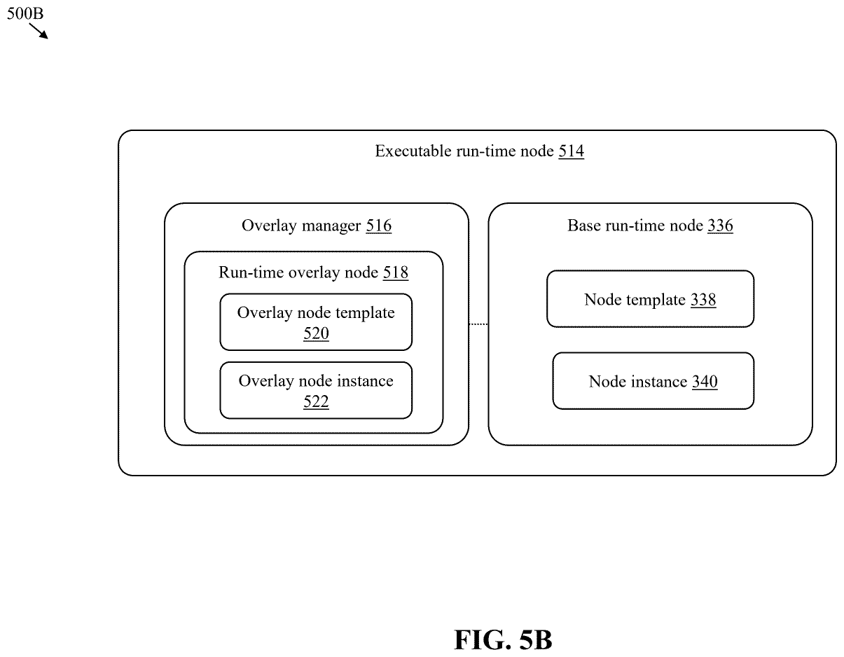

FIG. 5A is a block diagram 500A that illustrates an executable generic node 502 within the executable graph-based model 100, consistent with disclosed embodiments of the present disclosure. Referring to FIG. 5A, the executable generic node 502 is shown to include a base node (e.g., the generic node 302) and an overlay manager 504. For the sake of ongoing discussion, the base node corresponds to the generic node 302, and is hereinafter referred to as the “base node 302”. The base node 302 when extended by way of one or more overlay nodes becomes the executable generic node 502. The executable generic node 502 may have a first overlay node 506 and a second overlay node 508 associated therewith.

The overlay manager 504 registers and maintains one or more overlay nodes (such as the first and second overlay nodes 506 and 508) associated with the base node 302. The assignment of the first overlay node 506 and the second overlay node 508 to the base node 302 (via the overlay manager 504) endows the base node 302 with processing logic and executable functionality defined within the first and second overlay nodes 506 and 508.

The executable generic node 502 provides processing functionality (e.g., processing logic) to the base node 302 via one or more associated overlay nodes (for example, the first overlay node 506 and the second overlay node 508). Beneficially, the data and processing capability of the base node 302 may be dynamically and significantly extended using the concept of an executable node (for example, the executable generic node 502). As shown, the first overlay node 506 has a first overlay node-type 510 and the second overlay node 508 has a second overlay node-type 512. Therefore, the first overlay node 506 is associated with the first overlay node-type 510 and the second overlay node 508 is associated with the second overlay node-type 512. Examples of overlay node-types include, but are not limited to, a subscriber overlay node-type, a publisher overlay node-type, and an encryption overlay node-type.

A node with the subscriber overlay node-type is a subscriber overlay node that is indicative of an operation of receiving an input from an associated node. The subscriber overlay node also includes processing logic to receive the input. A node with the publisher overlay node-type is a publisher overlay node that is indicative of an operation of publishing an output of an associated node. The publisher overlay node also includes processing logic to publish the output. A node with the encryption overlay node-type is an encryption overlay node that is indicative of an encryption technique using which an associated node is to be secured. The encryption overlay node also includes processing logic to secure a corresponding node. Examples of the encryption technique include a symmetric encryption algorithm, an asymmetric encryption algorithm, a combination of these, or any other encryption technique.

Although, the executable generic node 502 is assumed to include the first and second overlay nodes 506 and 508, in other embodiments, the executable generic node 502 may include any number of overlay nodes, without deviating from the scope of the present disclosure.

The executable generic node 502 extends the base node 302 (or is a subtype of the base node 302) such that all the functionality and properties of the base node 302 are accessible to the executable generic node 502. The executable generic node 502 also dynamically extends the functionality of the base node 302 by associating the overlay nodes maintained by the overlay manager 504 with the base node 302. The executable generic node 502 may thus be considered a combination of the base node 302 and the first and second overlay nodes. The executable generic node 502 may be alternatively referred to as a node with overlay(s). Therefore, the executable generic node 502 acts as a decorator of the base node 302 adding the functionality of the overlay manager 504 to the base node 302.

It will be apparent to a person skilled in the art that the base node 302 refers to any suitable node within the executable graph-based model 100. As such, the base node 302 may be a node having a node-type such as a vertex node-type, an edge node-type, an overlay node-type, a role node-type, or the like. Alternatively, the base node 302 may be an executable node such that the functionality of the (executable) base node 302 is dynamically extended. In this way, complex and powerful processing functionality can be dynamically generated by associating and extending overlay nodes.

Extending the functionality of a base node through one or more overlay nodes is at the heart of the overlay system 202. As illustrated in FIG. 2, the data (e.g., a vertex node as represented by the base node 302 in FIG. 5A) and the functionality that acts upon that data (e.g., an overlay node) can be separated and independently maintained offline, but at run-time, an association between the base node and the overlay node is determined and an executable node is generated (e.g., the executable generic node 502 shown in FIG. 5A).

It will be apparent to a person skilled in the art that functionalities of the first and second overlay nodes 506 and 508 may be performed by a single overlay node that includes processing logic associated with both the first and second overlay nodes.

It will be apparent to a person skilled in the art that the list of overlay node-types is not exhaustive and the number of different overlay node-types that can be realized is not limited. Because an overlay node is itself a node, all functionality of a node described in relation to the base node 302 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

An overlay node, such as the first overlay node 506 or the second overlay node 508, is not bound to a single executable node or a single executable graph-based model (unlike nodes that have non-overlay node-types). This allows overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 504 of the executable generic node 502 is responsible for executing all overlays registered therewith. The overlay manager 504 also coordinates the execution of all associated overlay nodes. As shown in FIG. 5A, the executable generic node 502 associates the base node 302 with two overlay nodes that is the first overlay node 506 and the second overlay node 508. Thus, the overlay manager 504 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 504 and are associated with an overlay via a node configuration extension for the overlay.

FIG. 5B is a block diagram 500B that illustrates an executable run-time node 514 within the executable graph-based model 100, consistent with disclosed embodiments of the present disclosure. Referring to FIG. 5B, the executable run-time node 514 is shown to include the run-time node 336 (hereinafter referred to as ‘the base run-time node 336’) and an overlay manager 516. The base run-time node 336 may be associated with a run-time overlay node 518. Hence, the overlay manager 516 may include the run-time overlay node 518. The executable run-time node 514 provides processing functionality (e.g., processing logic) to the base run-time node 336 via one or more associated overlay nodes (for example, the run-time overlay node 518). Beneficially, the data and processing capability of the base run-time node 336 may be dynamically and significantly extended using the concept of an executable run-time node (for example, the executable run-time node 514).

Although, the executable run-time node 514 is shown to include a single run-time overlay node 518, in other embodiments, the executable run-time node 514 may include any number of run-time overlay nodes. The run-time overlay node 518 may include an overlay node template 520 and an overlay node instance 522. The overlay node template 520 and an overlay node instance 522 may, collectively, constitute the run-time overlay node 518.

The executable run-time node 514 extends the base run-time node 336 (or is a subtype of the base run-time node 336) such that all the functionalities and properties of the base run-time node 336 may be accessible to the executable run-time node 514. The executable run-time node 514 also dynamically extends the functionality of the base run-time node 336 by associating the run-time overlay nodes maintained by the overlay manager 516 with the base run-time node 336. The executable run-time node 514 may thus be considered a composition of the base run-time node 336 and the run-time overlay node 518. The executable run-time node 514 may be alternatively referred to as a run-time node with overlay(s). Therefore, the executable run-time node 514 acts as a decorator of the base run-time node 336 adding the functionality of the overlay manager 516 to the base run-time node 336.

It will be apparent to a person skilled in the art that the base run-time node 336 refers to any suitable run-time node within the executable graph-based model 100. As such, the base run-time node 336 may be a run-time node having a node-type such as a vertex-node-type, an edge node-type, or the like. Alternatively, the base run-time node 336 may itself be an executable node such that the functionality of the (executable) base run-time node 336 is dynamically extended. In this way, complex and powerful processing functionality can be dynamically generated by associating and extending overlay nodes.

The overlay manager 516 registers and maintains one or more run-time overlay nodes (such as the run-time overlay node 518) associated with the base run-time node 336. The assignment of the run-time overlay node 518 to the base run-time node 336 (via the overlay manager 516) endows the base run-time node 336 with processing logic and executable functionality defined within the run-time overlay node 518. In other words, the run-time overlay node 518 may interact at run-time, with the node template 338 and/or the node instance 340 of the base run-time node 336. In an example, the node template 338 and the node instance 340 may be not executable nodes. That is, neither the node template 338 nor the node instance 340 comprises an overlay manager with one or more run-time overlay nodes. In another example, the node template 338 and/or the node instance 340 may be executable nodes thereby extending the functionality, complexity, and configurability of executable run-time nodes.

Extending the functionality of a base run-time node through one or more run-time overlay nodes is at the heart of the overlay system 202. As illustrated in FIG. 2, the data (e.g., a vertex node as represented by the base run-time node 336 in FIG. 4B) and the functionality that acts upon that data (e.g., an overlay node) can be separated and independently maintained offline, but at run-time, an association between the base node and the run-time overlay node is determined and an executable run-time node is generated (e.g., the executable run-time node 514).

Each run-time overlay node comprises an overlay node template and an overlay node instance. The overlay node template is a node template with the overlay node-type template. Similarly, the overlay node instance is a node instance with the overlay node-type instance. The overlay node instance is an implementation of the overlay node template. The overlay node template comprises one or more generic rules that may be implemented by the processing logic of the overlay node instance. For example, a rule may be defined in an overlay node template specifying that hashing algorithm is to be used and an overlay instance associated with the overlay template provides a specific implementation of a hashing algorithm (e.g., Message-Digest Algorithm 5 (MD5), Secure Hash Algorithm-1 (SHA-1), SHA-2, etc.).

A run-time overlay node, such as the run-time overlay node 518, is a node having an overlay node-type (alternatively referred to as an overlay type) assigned to its node-type. Examples of overlay node-types include an encryption overlay node-type, an obfuscation overlay node-type, an audit overlay node-type, an analytics overlay node-type, a handler overlay node-type, a publisher overlay node-type, or the like. It will be apparent to a person skilled in the art that the list of overlay types is not exhaustive and the number of different overlay types that can be realized is not limited.

Because an overlay node is itself a node, all functionality of a node described in relation to the base run-time node 336 is thus applicable to an overlay node. For example, an overlay node may include a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

A run-time overlay node, such as the run-time overlay node 518, is not bound to a single executable node or a single executable graph-based model (unlike nodes that have non-overlay node-types). This allows run-time overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays.

Unlike non-run-time overlay nodes, a run-time overlay node may include processing logic (not shown in FIG. 5B) which determines the functionality of the run-time overlay node. The processing logic of a run-time overlay node may include a block of executable code, or instructions, which carries out one or more operations associated with the facilitation of indexing within the executable graph-based model 100. The block of executable code is pre-compiled code, code that requires interpretation at run-time, or a combination of both. Different run-time overlay nodes provide different processing logic to realize different functionality. The overlay manager 516 of the executable run-time node 514 is responsible for executing all overlays registered therewith. The overlay manager 516 also coordinates the execution of all associated overlay nodes. As shown in FIG. 5B, the executable run-time node 514 associates the base run-time node 336 with the run-time overlay node 518.

In some embodiments, the overlay manager 516 employs a strategy to manage potentially cascading execution flow of overlays such that one overlay may be associated with one or more other overlays. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies may be defined and registered with the overlay manager 516 and may be associated with an overlay via a node configuration extension for the overlay.

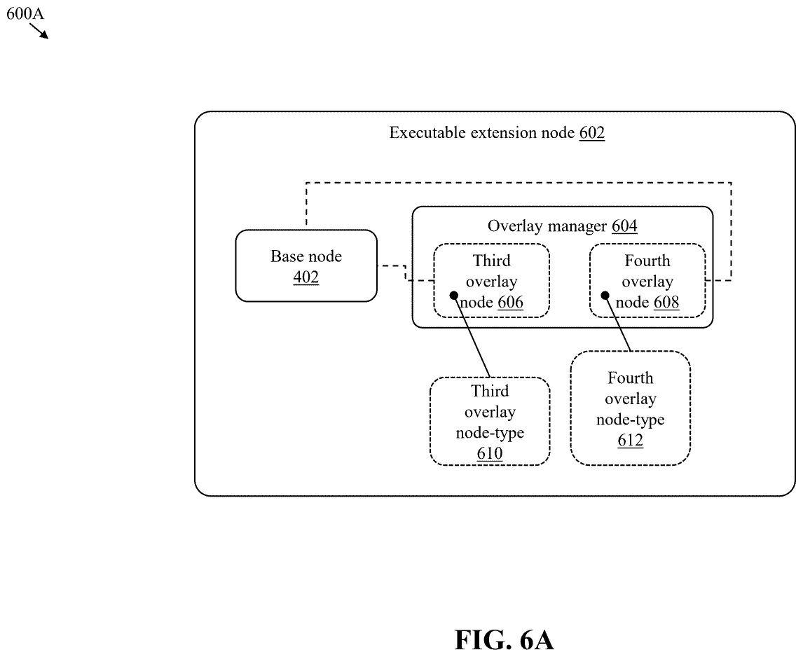

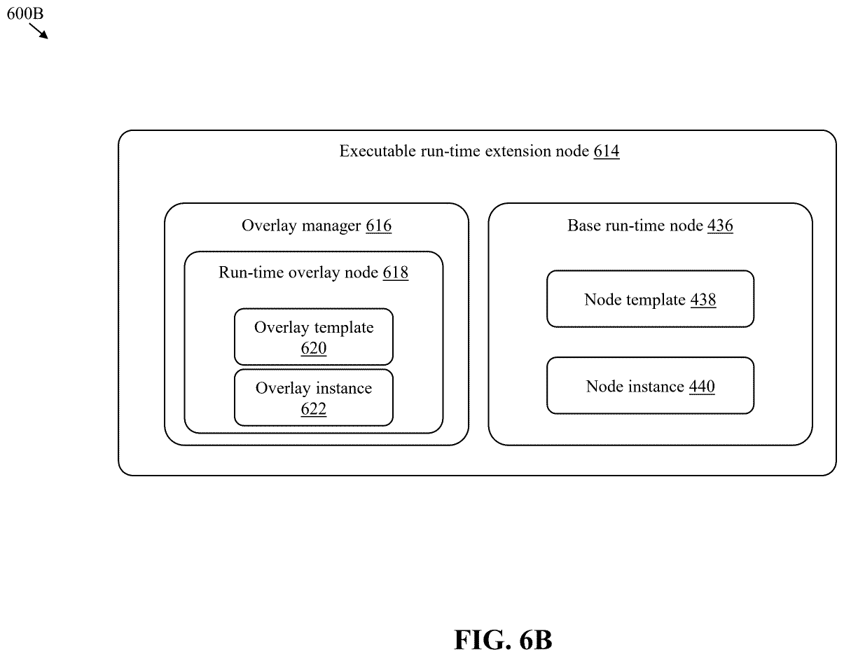

FIG. 6A is a block diagram 600A that illustrates an executable extension node 602 within the executable graph-based model 100, consistent with disclosed embodiments of the present disclosure. Referring to FIG. 6A, the executable extension node is shown to include a base node (for example, the extension node 402) and an overlay manager 604. Hereinafter, the base node is referred to as the base node 402. The base node 402 being an extension node may have the vertex extension node-type 428, the edge extension node-type 430, the overlay extension node-type 432, or the role extension node-type 434. The base node 402 may be associated with a third overlay node 606 and a fourth overlay node 608 associated therewith. Based on association with the third overlay node 606 and the fourth overlay node 608, the base node 402, in conjunction with the third overlay node 606 and the fourth overlay node 608, may be referred to as the executable extension node 602.

The overlay manager 604 has a description that is similar to the description of the overlay manager 504. The overlay manager 604 registers and maintains one or more overlay nodes (such as the third overlay node 606 and the fourth overlay node 608) associated with the base node 402.

The executable extension node 602 may have a description similar to the executable generic node 502. The base node 402 is extended by way of the third and fourth overlay nodes 606 and 608 in a manner similar to the extensions of the base node 302 by the first and second overlay nodes 506 and 508. Various concepts described for the executable generic node 502 in conjunction with FIG. 5A may also be applicable to the executable extension node 602.

It will be apparent to a person skilled in the art that the base node 402 refers to any suitable extension node within the executable graph-based model 100. As such, the base node 402 may be a node having an extension node-type such as a vertex extension node-type, an edge extension node-type, an overlay extension node-type, a role extension node-type, or the like. Alternatively, the base node 402 may be an executable extension node such that the functionality of the (executable) base node 402 is dynamically extended. In this way, complex and powerful processing functionality can be dynamically generated by associating and extending overlay nodes.

FIG. 6B is a block diagram 600B that illustrates an executable run-time extension node 614 within the executable graph-based model 100, consistent with disclosed embodiments of the present disclosure. Referring to FIG. 6B, the executable run-time extension node 614 is shown to include the run-time extension node 436 (hereinafter referred to as ‘the base run-time node 436’) and an overlay manager 616. The overlay manager 616 may include a run-time overlay node 618. The executable run-time extension node 614 may have a description similar to the executable run-time node 514.

Although, the executable run-time extension node 614 is shown to include a single run-time overlay node 618, in other embodiments, the executable run-time extension node 614 may include any number of run-time overlay nodes. The run-time overlay node 618 may include an overlay node template 620 and an overlay node instance 622. The overlay node template 620 and an overlay node instance 622 may, collectively, constitute the run-time overlay node 618.

The overlay manager 616 has a description that is similar to the description of the overlay manager 516. The overlay manager 616 registers and maintains one or more run-time overlay nodes (such as the run-time overlay node 618) associated with the base run-time node 436 as described in conjunction with FIG. 5B.

FIG. 7 is a block diagram 700 that illustrates a composition of the executable extension node 602 that enables persistent storage of data and the processing logic associated therewith, consistent with disclosed embodiments of the present disclosure.

As described in conjunction with FIG. 6A, the executable extension node 602 includes the base node 402 and one or more overlay nodes (e.g., the third and fourth overlay nodes 606 and 608). For the brevity of the ongoing description, the persistent storage is explained for the executable extension node 602 including only the third overlay node 606. One or more operations performed for ensuring the persistence of the third overlay node 606 may be performed for the fourth overlay node 608 as well.

Referring to FIG. 7, the executable extension node 602 includes the base node 402 and the third overlay node 606. The executable extension node 602 has a corresponding first state 702 having a first ID 704. The base node 402 has a second state 706 having a second ID 708, and the third overlay node 606 has a third state 710 having a third ID 712. A manifest (for example, first through third manifests 714-718) is generated for each of the executable extension node 602, the base node 402, and the third overlay node 606. In an embodiment, the manifests may be generated by the storage management module 220. The first manifest 714 is associated with the executable extension node 602 and has a fourth ID 720 and an overlay ID 722. The second manifest 716 is associated with the base node 402 and has a fifth ID 724. The third manifest 718 is associated with the third overlay node 606 and has a sixth ID 726. Further, the manifests are stored at respective storage locations that may be centralized or distributed storage locations associated with the overlay system 202. The manifests may be stored by the storage management module 220.

The first state 702 of the executable extension node 602 includes data required to reconstruct the executable extension node 602 (e.g., attributes, properties, etc.). The first state 702 of the executable extension node 602 is persistently stored along with the first ID 704. The first manifest 714 is generated for the executable extension node 602 and has (i) the fourth ID 720 (which is the same as the first ID 704), (ii) the storage location of the first state 702 of the executable extension node 602, and (iii) the overlay ID 722 (which is the same as the sixth ID 726). Notably, the fourth ID 720 is the same as the first ID 704 and the fifth ID 724, hence, the first manifest 714 includes the ID of the state of the base node 402 and the executable extension node 602. Further, the overlay ID 722 is the same as the sixth ID 726 of the state of the third overlay node 606. Therefore, the first manifest 714 may be used to identify and retrieve the states of the base node 402, the executable extension node 602, and the third overlay node 606. Subsequently, the retrieved states may be used to reconstruct the executable extension node 602 and the third overlay node 606. In an instance, the executable extension node 602 may be further extended to include additional overlay nodes. In such an instance, the first manifest 714 may include state IDs of the additional overlay nodes as well. A first manifest state (not shown) is then generated for the first manifest 714 and persistently stored along with the fourth ID 720.

The second state 706 of the base node 402 includes data required to reconstruct the base node 402 (e.g., attributes, properties, etc.) and is persistently stored along with the second ID 708. The second manifest 716 is generated for the base node 402 and has the fifth ID 724 and the storage location of the second state 706 of the base node 402. The second ID 708 of the second state 706 and the fifth ID 724 of the second manifest 716 are the same as the first ID 704 of the first state 702 of the executable extension node 602 (which is also the same as the fourth ID 720 of the first manifest 714 of the executable extension node 602). As mentioned above, along with the first state 702, the first manifest 714 may also be used to identify and retrieve the second manifest 716 which in turn may be used to identify the second state 706 of the base node 402. A second manifest state (not shown) is then generated for the second manifest 716 and persistently stored along with the fifth ID 724. Thus, the states, manifests, and manifest states for the executable extension node 602 and the base node 402 include the same, shared, ID. A shared ID can be used in this instance because the states, manifests, and manifest states are stored separately. The separate storage of the states, manifests, and manifest states exhibit a distributed architecture of the overlay system 202.

The third state 710 of the third overlay node 606 includes data required to reconstruct the third overlay node 606 (e.g., attributes, properties, processing logic, etc.) and is persistently stored along with the third ID 712. The third manifest 718 is generated for the third overlay node 606 and includes the sixth ID 726, which is the same as the third ID 712. Therefore, the first manifest 714 may be further used to identify and retrieve the third manifest 718 which in turn may be used to identify and retrieve the third state 710 of the third overlay node 606. A third manifest state (not shown) is then generated for the third manifest 718 and is persistently stored along with the sixth ID 726.

In operation, when the executable extension node 602 is to be loaded, the transaction module 208, in conjunction with the storage management module 220, may execute one or more operations to retrieve the first manifest state stored at a known storage location. Based on the first manifest state, the storage management module 220 may re-construct the first manifest 714 which includes the fourth ID 720 which is the same as the fifth ID 724 of the second manifest 716. Based on the fifth ID 724, the storage management module 220 may identify the second manifest state and may generate the second manifest 716 based on which the second state 706 is identified. Subsequently, the base node 402 is loaded and the storage management module 220 may determine that the base node is a node with overlay. Based on the fourth ID 720 (that is the same as the first ID 704 of the first state 702 of the executable extension node 602) of the first manifest 714, the first state 702 is identified and retrieved. Subsequently, the executable extension node 602 is loaded. Moreover, based on the overlay ID 722 (that is the same as the sixth ID 726 of the third manifest 718) of the first manifest 714, the third manifest state is identified and the third manifest 718 is generated. Subsequently, based on the sixth ID 726 (that is the same as the third ID 712 of the third state 710) of the third manifest 718, the third state 710 is identified and retrieved. Based on the third state 710, the third overlay node 606 is reconstructed and loaded in the executable graph-based model 100.

Based on a context of a stimulus (for example, the stimulus 230) associated with the overlay system 202, the processing logic (such as the context module 210) may determine an ID that is the same as the fifth ID 724. Based on the determined ID, the processing logic (such as the memory management module 218 and the storage management module 220) may identify the second manifest 716. Subsequently, the processing logic (such as the memory management module 218 and the storage management module 220) may identify the second state 706 that has the second ID 708 that matches the fifth ID 724. Further, the processing logic (such as the memory management module 218 and the storage management module 220) may retrieve the second state 706 associated with the second manifest 716 from a corresponding storage element. Subsequently, the processing logic (such as the memory management module 218 and the storage management module 220) may determine, by checking the manifest storage(s) associated with the overlay system 202, whether there is another manifest (such as the first manifest 714 of the executable extension node 602) with an ID that matches the second ID 708 and the fifth ID 724. Notably, the first manifest 714 includes storage locations of each overlay node (for example, the third overlay node 606) of the executable extension node 602. Based on the overlay ID 722 included in the first manifest 714 that matches the sixth ID 726 included in the third manifest 718, the processing logic (such as the memory management module 218 and the storage management module 220) may identify and retrieve the third manifest 718 from a manifest storage of a plurality of manifest storages of the overlay system 202. Subsequently, the processing logic (such as the memory management module 218 and the storage management module 220) may identify the third state 710 which has the third ID 712 that matches the sixth ID 726. Further, the processing logic (such as the memory management module 218 and the storage management module 220) may retrieve the third state 710 associated with the third manifest 718 from a corresponding storage element. To determine whether the third overlay node 606 has an overlay node associated therewith, the processing logic (such as the memory management module 218 and the storage management module 220) may also perform a check to determine whether any of the plurality of manifest storages of the overlay system 202 includes any other manifest with an ID that matches the sixth ID 726. Since the third overlay node 606 does not have an overlay associated therewith, no other manifest has the ID that matches the sixth ID 726.

Notably, the manifest (the third manifest 718) of the third overlay node 606 includes a reference (such as an identifier that is common to the second manifest 716 and the third manifest 718, a link, a path, a storage location, or the like) to the second manifest 716 of the base node 402. Therefore, the re-formation of the executable extension node 602 includes a re-creation of the third overlay node 606 prior to a re-creation of the base node 402. Subsequently, the third overlay node 606 and the base node 402 are organized by associating the base node 402 with the third overlay node 606 to re-form the executable extension node 602.

In some embodiments, the third overlay node 606 may not be loaded in case it is not required for executing the operation associated with the stimulus 230. The loaded executable extension node 602 and the third overlay node 606 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states are stored together at a storage location (such as a manifest storage) that is known to the storage management module 220. Such centralized storage of the manifest states ensures that node states associated therewith are easily accessible.

It will be apparent to a person skilled in the art that although FIG. 7 illustrates only a single overlay node associated with an extension node, in other embodiments, the executable extension node 602 may include additional or different overlay nodes. It will also be apparent to a person skilled in the art that only those overlay nodes that are required for responding to the stimulus 230 may be loaded.

Additionally, the executable extension node 602 may further include one or more identifiers of one or more source nodes (for example, the generic node 302) associated therewith i.e., one or more active nodes associated therewith. Therefore, based on the loading of the executable extension node 602, the identifiers may be determined and the associated active nodes may be loaded as described above.

For the sake of simplicity of the description, it is assumed herein that the extension node 402 is implemented by the generic node 302 whereas the run-time extension node 436 is implemented by the run-time node 336. Notably, based on the generic node 302 being a non-templated node, the extension node 402 is a generic node i.e., non-templated node. A non-templated node is a node that is not a run-time node and does not have a node template and a node instance. Additionally, based on the run-time node 336 being a run-time node, the run-time extension node is also a run-time node and includes the node template 338 and the node instance 340. Node template of an extension node corresponds to an extension node template and node instance of an extension node corresponds to an extension node instance.

The executable extension node 602 or the base node 402 may include an identifier of the generic node 302. Therefore, based on the loading of the executable extension node 602, the generic node 302 may also be loaded. The generic node 302 may be loaded in a manner similar to the loading of the base node 402. The generic node 302, when associated with an overlay node, may be loaded in a manner similar to the loading of the executable extension node 602.

The executable run-time extension node 614 may be loaded by loading the extension node template 438 and the extension node instance 440. Each of the extension node template 438 and the extension node instance 440 may be loaded in a manner similar to the loading of the base node 402 as described in conjunction with FIG. 7. Additionally, the extension node instance 440 may include a reference to the extension node template 438. Therefore, the extension node template 438 may be identified based on the extension node instance 440 and may be loaded prior to the extension node instance 440. Also, each of the extension node template 438 and the extension node instance 440 may include a reference (for example, an identifier) to one or more node templates and one or more node instances, respectively, of one or more run-time nodes associated with the executable run-time extension node 614 as source nodes thereof. Therefore, based on the loading of the extension node template 438, the associated node templates may be loaded. Similarly, based on the loading of the extension node instance 440, the associated node instances may be loaded. In some embodiments, the extension node template 438 and the extension node instance 440 may be associated with node templates and node instances, respectively, of one or more run-time overlay nodes or one or more run-time extension overlay nodes associated with the executable run-time extension node 614. In such embodiments, based on loading each of the extension node template 438 and the extension node instance 440, node templates and node instances of the one or more run-time overlay nodes or the one or more run-time extension overlay nodes may be loaded in a manner as described in conjunction with FIG. 7.

In some embodiments, the run-time node 336 may be loaded by loading the node template 338 and the node instance 340. Each of the node template 338 and the node instance 340 of the run-time node 336 may be loaded in a manner similar to the loading of the base node 402. Additionally, in an instance when the run-time node 336 may be extended by way of a run-time overlay node, the node template 338 and the node instance 340 may be associated with overlay node template and overlay node instance, respectively, of the run-time overlay node. In such a scenario, each of the node template 338 and the node instance 340 may be loaded in a manner similar to the loading of the executable extension node 602.

Notably, based on loading of an extension node, active nodes associated therewith may also be loaded. In other words, based on the loading of the extension node 402 for use thereof, sources nodes (i.e., the generic node 302) associated therewith may also be loaded.

Notably, an extension node (for example, the extension node 402, the run-time extension node 436, the executable extension node 602, and the executable run-time extension node 614) may be a stateful node or a stateless node. Based on the extension node being the stateful node, a state of the extension node persists in the storage element of the overlay system 202 upon unloading thereof. The state of the extension node may be used to re-generate/load the extension node in the executable graph-based model 100 based on a requirement thereof as described herein. Further, based on the extension node being the stateless node, the state of the extension node may cease to exist in the storage element upon unloading thereof from the executable graph-based model 100. That is to say that, the extension node may be discarded from the overlay system 202 based on the unloading thereof. Similarly, a run-time extension node (for example, the run-time extension node 436) may also be the stateless node or stateful node.

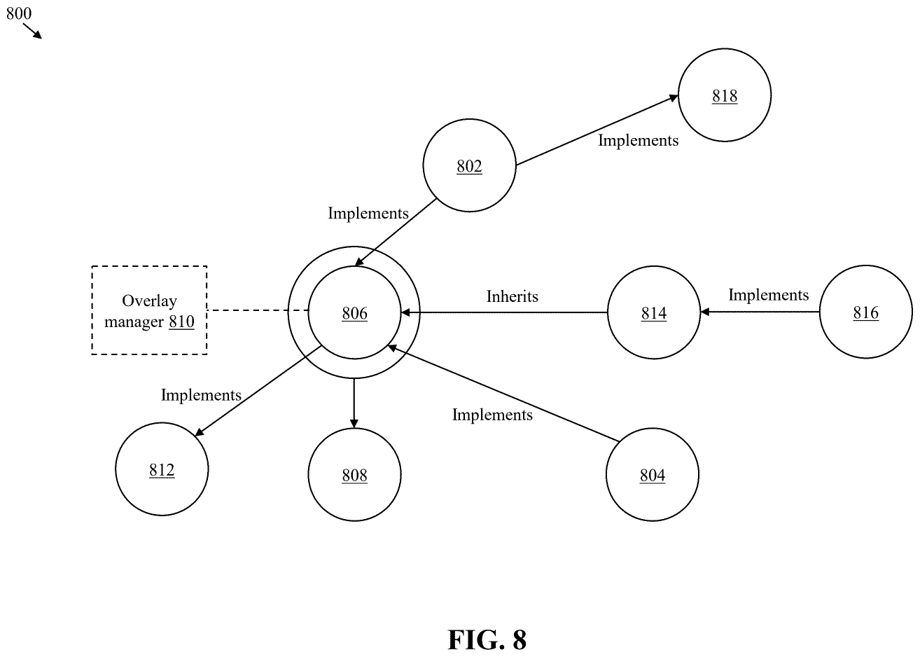

FIG. 8 illustrates a graph 800 that depicts implementation of the plurality of extension nodes in conjunction with the generic nodes in the executable graph-based model 100, consistent with disclosed embodiments of the present disclosure.

Referring to FIG. 8, shown are the plurality of active nodes including generic nodes 802 and 804. Each of the plurality of active nodes such as, the generic nodes 802 and 804, may have a corresponding initial functionality associated therewith. An initial functionality of an active node corresponds to a functionality of the active node. The initial functionality may be data associated with the active node or processing logic associated with the active node. The initial functionality of the active node may be data and/or processing logic based on a node-type of the active node. The active node may have a vertex node-type (for example, the vertex node-type 328), an edge node-type (for example, the edge node-type 330), an overlay node-type (for example, the overlay node-type 332), or a role node-type (for example, the role node-type 334). For example, based on an active node (for example, the generic node 802) having the vertex node-type (for example, the vertex node-type 328), the active node may have an initial functionality in form of data associated therewith. In another example, based on an active node (for example, the generic node 802) having an edge node-type (for example, the edge node-type 330), the active node may have an initial functionality in form of associations, metadata, or roles defined thereby. In another example, based on an active node (for example, the generic node 802) having an overlay node-type (for example, the overlay node-type 332), the active node may have an initial functionality in form of processing logic associated therewith. It is assumed that the generic nodes 802 and 804 shown herein are non-modifiable nodes. For example, the generic nodes 802 and 804 may be leaf nodes or owned nodes and data and/or processing logic associated therewith may not be modified.

The processing circuitry (for example, the controller module 206, the transaction module 208, the stimuli management module 212, or the like) may receive a first stimulus (for example, the stimulus 230). The first stimulus may be an internal stimulus or an external stimulus. The first stimulus may be indicative of a transaction being executed based on the generic node 802. In addition, one or more operations of the transaction may require to: (i) modify a first initial functionality of the generic node 802, (ii) use the modified first initial functionality of the generic node 802, or (iii) modify the first initial functionality and use the modified first initial functionality of the generic node 802. The first stimulus may be indicative of a first extension operation associated with the overlay system 202. The first stimulus may be further indicative of an extension of the first initial functionality of the generic node 802. The first stimulus may be further indicative of a first extended functionality that is to be associated with the first initial functionality for extension thereof. In other words, the first stimulus may be further indicative of the first initial functionality of the generic node 802 and a first extended functionality that is to be added or combined with the first initial functionality for extension thereof.

An extended functionality (for example, the first extended functionality) may be a functionality that may be associated with an initial functionality of an active node for extension of the initial functionality. The extension of the initial functionality may correspond to modification of the initial functionality to add additional/new capabilities. The extended functionality (for example, the first extended functionality) may be a data functionality or an operational functionality. Data functionality may refer to data defined in association with an active node or an extension node that may be used by the processing circuitry (for example, the controller module 206, the transaction module 208, or the like) in execution of one or more operations associated with the overlay system 202. Operational functionality may refer to processing logic defined in association with an active node or an extension node that may be executed by the processing circuitry (for example, the controller module 206, the transaction module 208, or the like) to perform one or more operations/transactions associated with the overlay system 202.

Based on the first stimulus, the processing circuitry (for example, the controller module 206, the transaction module 208, the stimuli management module 212, or the like) may be configured to identify the generic node 802. The generic node 802 may be identified based on context of the first stimulus. In an example, the first stimulus may be further indicative of an identifier associated with the first generic node.

Upon the identification of the generic node 802, the processing circuitry (for example, the controller module 206, the transaction module 208, the stimuli management module 212, or the like) may determine whether the generic node 802 is unloaded from the executable graph-based model 100. Based on the generic node 802 being unloaded from the executable graph-based model 100, the processing circuitry (for example, the memory management module 218, the storage management module 220, or the like) may be configured to load the generic node 802 in the executable graph-based model 100.

Based on the first stimulus, the processing circuitry (for example, the controller module 206, the transaction module 208, the extension management module 236, or the like) may be configured to create an extension node 806. The extension node 806 may be associated with the first extended functionality. In some embodiments, the processing circuitry (for example, the controller module 206, the transaction module 208, the extension management module 236, or the like) may be configured to associate an extension node-type (for example, the extension node-type 408) with the extension node 806. The extension node-type may be a vertex extension node-type (for example, the vertex extension node-type 428), an edge extension node-type (for example, the edge extension node-type 430), an overlay extension node-type (for example, the overlay extension node-type 432), or a role extension node-type (for example, the role extension node-type 434).

In one embodiment, the processing circuitry (for example, the controller module 206, the transaction module 208, the extension management module 236, or the like) may be configured to determine the extension node-type to be associated with the extension node 806 based on the first extended functionality. In an instance, when the first extended functionality may be the data functionality, the first extension node-type may be the vertex extension node-type, the edge extension node-type, or the role extension node-type. In another instance, when the first extended functionality may be the operational functionality, the first extension node-type may be the overlay extension node-type.

In some embodiments, the first extended functionality associated with the extension node 806 may be a combination of the data functionality and the operational functionality. In such embodiments, the first extension node-type may be the overlay extension node-type.

In another embodiment, the processing circuitry (for example, the controller module 206, the transaction module 208, the extension management module 236, or the like) may be configured to determine the first extension node-type, to be associated with the extension node 806, based on a node-type of the generic node 802. In an instance, when the generic node 802 may have a vertex node-type (for example, the vertex node-type 328), the first extension node-type may be the vertex extension node-type. That is to say that, the first initial functionality of the generic node 802 may be ‘data’ and the first extended functionality of the extension node 806 may be data functionality which extends the first initial functionality ‘data’. In another instance, when the generic node 802 may have an edge node-type (for example, the edge node-type 330), the first extension node-type may be the edge extension node-type. That is to say that, the first initial functionality of the generic node 802 may be data indicative of association between two or more nodes and the first extended functionality of the extension node 806 may be data functionality that is indicative of additional associations between the two or more nodes or metadata pertaining to the association between the two or more nodes. In another instance, when the generic node 802 may have an overlay node-type (for example, the overlay node-type 332), the first extension node-type may be the overlay extension node-type. That is to say that, the first initial functionality of the generic node 802 may be ‘processing logic’ and the first extended functionality of the extension node 806 may be operational functionality which extends the first initial functionality ‘processing logic’. In another instance, when the generic node 802 may have a role node-type (for example, the role node-type 334), the first extension node-type may be the role extension node-type. That is to say that, the first initial functionality of the generic node 802 may be ‘data’ indicative of a capacity in which two or more nodes are associated and the first extended functionality of the extension node 806 may be data functionality which may be indicative of additional capacity in which the two or more nodes may be associated. In some embodiments, the first extension node-type may be different from the node-type of the generic node 802. In an example, the generic node 802 may have the overlay node-type. Based on a requirement of associating the processing logic with a dataset, the extension node 806 may be created such that the extension node 806 may have a vertex extension node-type. In such an example, the overlay node-type of the generic node 802 may be different from the vertex extension node-type of the extension node 806.

In some embodiments, the processing circuitry (for example, the controller module 206, the transaction module 208, the extension management module 236, or the like) may not associate the extension node 806 with the extension node-type. In an instance, the first extended functionality may correspond to a new component or component value (for example, attribute, metadata, label, or the like) to be added to a standard structure of a generic node (for example, the generic node 802). In such an instance, the extension node 806 may not be associated with an extension node-type.

The processing circuitry (for example, the controller module 206, the transaction module 208, the extension management module 236, or the like) may be configured to associate the extension node 806 with the generic node 802. Based on the association, the first initial functionality of the generic node 802 may be accessible by way of the extension node 806. Therefore, the first initial functionality of the generic node 802 as well as the first extended functionality may be used by way of the extension node 806. The generic node 802 may act as a first source node for the extension node 806. Hence, the generic node 802 may be said to implement the extension node 806. Also, based on the association of the extension node 806 with the generic node 802, the extension node 806 may include a first reference (for example, a pointer, a storage location, or the like) of the generic node 802. Hence, based on a loading of the extension node 806, the generic node 802 may also be loaded, in the executable graph-based model 100 as described in conjunction with FIG. 7. This marks the completion of the first extension operation associated with the first stimulus. To summarize, the first extension operation facilitates an extension of the first initial functionality of the generic node 802 by appending the first extended functionality to the first initial functionality by way of the extension node 806.

In an example, the generic node 802 may be a vertex node i.e., a node with a vertex node-type (for example, the vertex node-type 328). The first stimulus may be indicative of extension of the first initial functionality of the generic node 802 by way of the first extended functionality. The first initial functionality may be data associated with the generic node 802 and the first extended functionality may be a data functionality. Therefore, the processing circuitry (for example, the controller module 206, the transaction module 208, or the like) may create the extension node 806 with a vertex extension node-type (for example, the vertex extension node-type 428). The processing circuitry (for example, the controller module 206, the transaction module 208, or the like) may associate the extension node 806 with the vertex extension node-type with the generic node 802. Based on the association with the generic node 802, the extension node 806 may exhibit the first initial functionality ‘data’ as well as the first extended functionality that is the data functionality. Hence, the extension node 806 may be used to access the data associated with the first initial functionality as well as the data functionality associated with the first extended functionality.

In another example, the generic node 802 may be a vertex node i.e., a node with a vertex node-type (for example, the vertex node-type 328). The first stimulus may be indicative of extension of the first initial functionality of the generic node 802 by way of the first extended functionality. The first initial functionality may be data associated with the generic node 802 and the first extended functionality may be an operational functionality. Therefore, the processing circuitry (for example, the controller module 206, the transaction module 208, or the like) may create the extension node 806 with an overlay extension node-type (for example, the overlay extension node-type 432). The processing circuitry (for example, the controller module 206, the transaction module 208, or the like) may associate the extension node 806 with the overlay extension node-type with the generic node 802. Based on the association with the generic node 802, the extension node 806 may exhibit the first initial functionality ‘data’ as well as the first extended functionality which is the operational functionality. Hence, the extension node 806 may be used to access the data associated with the first initial functionality as well as the operational functionality associated with the extended functionality.

In another example, the first extended functionality may be data functionality being an additional set of attributes to be added to the generic node 802. In such an example, the processing circuitry (for example, the controller module 206, the transaction module 208, or the like) may generate the extension node 806 that may not be associated with an extension node-type. The extension node 806 may include the additional set of attributes and a set of attribute values associated therewith. Based on association with the generic node 802, the extension node 806 may exhibit each node element of a standard structure of the generic node 802 in addition to the additional set of attributes.

The processing circuitry (for example, the controller module 206, the transaction module 208, the stimuli management module 212, or the like) may be further configured to receive a second stimulus (for example, the stimulus 230) indicative of a utilization operation associated with the extension node 806. The utilization operation may be indicative of a transaction to be performed using the first extended functionality and optionally the first initial functionality of the generic node 802. The processing circuitry (for example, the controller module 206, the transaction module 208, the stimuli management module 212, or the like) may be further configured to identify the extension node 806 based on a context of the second stimulus. Subsequently, based on the identification of the extension node 806, the processing circuitry (for example, the controller module 206, the transaction module 208, the stimuli management module 212, or the like) may be further configured to determine the one or more source nodes (for example, the generic node 802) associated with the extension node 806. The processing circuitry (for example, the controller module 206, the transaction module 208, the stimuli management module 212, or the like) may determine the generic node 802 based on the first reference thereof being associated with the extension node 806.

Moreover, based on the second stimulus, the processing circuitry (for example, the controller module 206, the transaction module 208, the stimuli management module 212, or the like) may be further configured to determine whether the extension node 806 is unloaded from the executable graph-based model 100. Based on the determination that the extension node 806 is unloaded from the executable graph-based model 100, the processing circuitry (for example, the memory management module 218, the storage management module 220, or the like) may be configured to load the extension node 806 as described in conjunction with FIG. 7. In addition, the processing circuitry (for example, the memory management module 218, the storage management module 220, or the like) may be configured to use the first reference associated with the extension node 806 to load the generic node 802 as described in conjunction with FIG. 7. Subsequently, the processing circuitry (for example, the controller module 206, the transaction module 208, the stimuli management module 212, or the like) may execute one or more operations associated with the utilization operation indicated by the second stimulus.

Upon execution of the utilization operation, the processing circuitry (for example, the memory management module 218, the storage management module 220, or the like) may be configured to unload the extension node 806 and optionally, the generic node 802. Notably, an extension node, such as the extension node 806, may be the stateful node or the stateless node as described previously in the description. Therefore, based on the extension node 806 being the stateful node, the extension node 806 may persist in the storage element upon the unloading thereof. Hence, based on the extension node 806 being the stateful node, the first extended functionality may persist in the storage element upon the unloading of the extension node 806. Alternatively, based on the extension node 806 being the stateless node, the extension node 806 may be discarded from the overlay system 202 upon the unloading thereof. Hence, based on the extension node 806 being the stateless node, the extension node 806 may be discarded from the overlay system 202 and hence, may cease to exist in the overlay system 202 upon the unloading of the extension node 806.

In some embodiments, the first stimulus may be further indicative of associating/incorporating an additional functionality to the first extension node 806 upon its creation. Therefore, based on the first stimulus, the processing circuitry (for example, the controller module 206, the transaction module 208, the stimuli management module 212, or the like) may be configured to identify an overlay node 808 of a plurality of overlay nodes of the executable graph-based model 100. The overlay node 808 may be a generic overlay node (for example, the first overlay node 506). Alternatively, the processing circuitry (for example, the controller module 206, the transaction module 208, the stimuli management module 212, or the like) may be configured to create the overlay node 808 having an overlay extension node-type (for example, the overlay extension node-type 432). The overlay node 808 may be identified or created based on the corresponding functionality being in conformity with the additional functionality indicated by the first stimulus. In other words, the overlay node 808 may be identified or created based on corresponding processing logic, when executed, being able to perform the additional functionality. Subsequently, based on the identification or the creation of the overlay node 808, the processing circuitry (for example, the controller module 206, the transaction module 208, the stimuli management module 212, or the like) may be configured to associate the overlay node 808 with the extension node 806. Such association of the overlay node 808 with the extension node 806 incorporates the additional functionality to the extension node 806. The utilization operation associated with the first extension node 806 may be executed further based on the overlay node 808.

The extension node 806 may further include an overlay manager 810 configured to manage the association of the extension node 806 with the overlay node 808. The overlay manager 810 may have a description similar to the description of the overlay manager 504.

In some embodiments, the extension node 806 may be a non-modifiable node. In addition, the first stimulus may be further indicative of modification of the first extended functionality and optionally the initial functionality of the generic node 802. Therefore, based on the first stimulus, the processing circuitry (the controller module 206, the transaction module, the extension management module 236) may be further configured to create an extension node 812 associated with a second extended functionality. Further, based on the first stimulus, the processing circuitry (the controller module 206, the transaction module, the extension management module 236) may be configured to associate the extension node 812 with the extension node 806. Therefore, the extension node 806 may implement the extension node 812. In other words, the extension node 806 may be a source node for the extension node 812. Based on the association with the extension node 806, the extension node 812 may exhibit the first initial functionality of the generic node 802, the first extended functionality of the extension node 806, and the second extended functionality. The second extended functionality may extend the first extended functionality and optionally the first initial functionality.

It will be apparent to a person skilled in the art that creation of extension nodes is not limited to associating extended functionalities only to nonmodifiable nodes. In some embodiments, an extension node for a first active node may be created by a first user of the overlay system 202 and a second user of the overlay system 202 may further create a second extension node in association with the first extension node to further add functionalities to the first active node. This allows for cascading of extension nodes in association with the first active node. In addition, such a cascading also allows for collaboration among different users of the overlay system 202.

In some embodiments, the extension node-type of the extension node 806 may be same as (namely, matches) the extension node-type of the extension node 812. In an example, the extension node 806 may have the overlay extension node-type. Therefore, the first extended functionality may be the operational functionality. Based on a requirement of associating an additional operational functionality to the first extended functionality of the extension node 806, the extension node 812 may have the overlay extension node-type.

In some embodiments, the extension node-type of the extension node 806 may be different from the extension node-type of the extension node 812. In an example, the extension node 806 may have the vertex extension node-type. Therefore, the first extended functionality may be the data functionality. Based on a requirement of associating an operational functionality to the first extended functionality of the extension node 806, the extension node 812 may have the operational functionality.

In some embodiments, the extension node 806 may inherit one or more other extension nodes of the executable graph-based model 100. As shown, the extension node 806 may inherit an extension node 814 implemented by a generic node 816. The extension node 814 may have a second extended functionality and the generic node 816 may have a second initial functionality. Therefore, the extension node 814 may exhibit the second initial functionality and the second extended functionality. Based on the extension node 806 inheriting the extension node 814 may exhibit the first and second initial functionalities and the first and second extended functionalities.

The processing circuitry (for example, the controller module 206, the transaction module 208, or the like) may receive a third stimulus indicative of a second extension operation indicative of extension of a third initial functionality of the generic node 802 by way of a third extended functionality. The third extended functionality may be different from the first and second extended functionalities. Based on the third stimulus, the processing circuitry (for example, the controller module 206, the transaction module 208, the extension management module 236, or the like) may create an extension node 818 in a manner similar to the creation of the extension node 806. The extension node 818 may be associated with the third extended functionality. Further, based on the third stimulus, the processing circuitry (for example, the controller module 206, the transaction module 208, the extension management module 236, or the like) may associate the extension node 818 with the generic node 802. Based on the association with the generic node 802, the extension node 818 may exhibit the first initial functionality, the third initial functionality, and the third extended functionality. In such a scenario, the extension node 806 may also exhibit the first initial functionality, the third initial functionality, and the first extended functionality.

In some embodiments, the processing circuitry (for example, the controller module 206, the transaction module 208, the stimuli management module 212, or the like) may receive a fourth stimulus indicative of a third extension operation. The third extension operation may be associated with a requirement for an extension of a fourth initial functionality of the generic node 804 of the executable graph-based model 100. The processing circuitry (for example, the stimuli management module 212, or the like) may be configured to identify the generic node 804 based on a context of the fourth stimulus. The processing circuitry (for example, the controller module 206, the transaction module 208, the stimuli management module 212, or the like) may be further configured to traverse the executable graph-based model 100 by analyzing various extension nodes in the executable graph-based model 100 based on associated extended functionalities. Based on the traversal and the analysis, the processing circuitry (for example, the controller module 206, the transaction module 208, the stimuli management module 212, or the like) may be further configured to compare the required extension of the fourth initial functionality indicated by the fourth stimulus with extended functionalities of each extension node of the executable graph-based model 100.

Based on a comparison of the required extension with the first extended functionality of the extension node 806, the processing circuitry (for example, the controller module 206, the transaction module 208, the stimuli management module 212, the extension management module 236, or the like) may determine that the required extension of the fourth initial functionality matches the first extended functionality. Subsequently, based on the required extension of the fourth initial functionality being a match to the first extended functionality, the processing circuitry (for example, the controller module 206, the transaction module 208, the stimuli management module 212, the extension management module 236, or the like) may identify the extension node 806. Based on the required extension of the fourth initial functionality being the match to the first extended functionality and the identification of the extension node 806, the processing circuitry (for example, the controller module 206, the transaction module 208, the stimuli management module 212, the extension management module 236, or the like) may determine that the required extension of the fourth initial functionality may correspond to the first extended functionality. In other words, an extended functionality for implementing the required extension of the fourth initial functionality may correspond to the first extended functionality.

Subsequently, the processing circuitry (for example, the controller module 206, the transaction module 208, the stimuli management module 212, the extension management module 236, or the like) may associate, in response to the fourth stimulus, the extension node 806 with the generic node 804. Based on the association of the extension node 806 with the generic node 804, the fourth initial functionality of the generic node 804 may be accessible by way of the extension node 806. Therefore, the fourth initial functionality of the generic node 804 as well as the first extended functionality may be used by way of the extension node 806. The generic node 804 may act as a second source node of the extension node 806. Hence, the generic node 804 may be said to implement the extension node 806. Also, based on the association of the extension node 806 with the generic node 804, the extension node 806 may further include a second reference (for example, a pointer, a storage location, or the like) of the generic node 804. Therefore, based on the loading of the extension node 806, in addition to the generic node 802, the generic node 804 may also be loaded in the executable graph-based model 100.

Having discussed the implementation of the extension nodes in conjunction with active nodes that may be generic nodes, the description now moves towards implementation of the extension nodes in conjunction with the active nodes that may be run-time nodes.

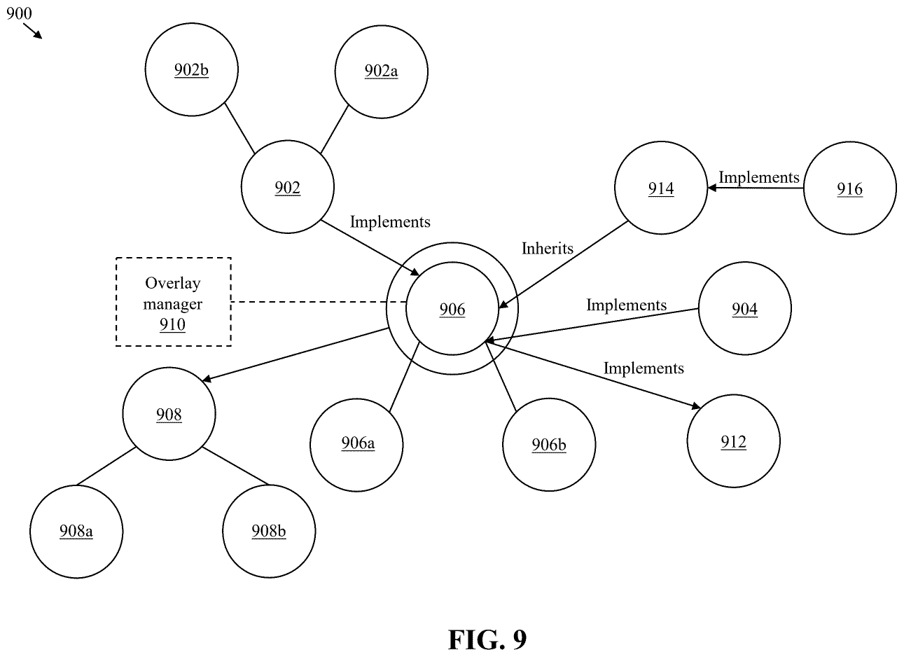

FIG. 9 illustrates a graph 900 that depicts implementation of the plurality of extension nodes in conjunction with the run-time nodes in the executable graph-based model 100, consistent with disclosed embodiments of the present disclosure.

Referring to FIG. 9, the executable graph-based model 100 is shown to include a plurality of run-time nodes including run-time nodes 902 and 904. As described previously, each run-time node (for example, the run-time node 336) is associated with a node template and a node instance. As shown, the run-time node 902 includes a node template 902a and a node instance 902b. Similarly, the run-time node 904 may also include a node template (not shown) and a node instance (not shown). Various embodiments, functionalities, and description associated with the generic nodes 802 and 804 for implementation of one or more extension nodes may also be applicable to the run-time nodes 902 and 904.

The run-time nodes 902 and 904 are further shown to be associated with a run-time extension node 906. In other words, functionalities of the run-time nodes 902 and 904 may be extended by way of the run-time extension node 906. The run-time extension node 906 may be associated with the run-time nodes 902 and 904 in a manner similar to the association of the extension node 806 with the generic nodes 802 and 804. Various embodiments and concepts described with respect to the implementation of the extension node 806 may also be applicable to the run-time extension node 906. Further, based on the active nodes shown in FIG. 9 being run-time nodes (for example, the run-time nodes 902 and 904) extension nodes associated therewith may also be run-time extension nodes and may include corresponding extension node templates and corresponding extension node instances. For example, the run-time extension node 906 is shown to include an extension node template 906a and an extension node instance 906b.

The run-time extension node 906 is further shown to be associated with a run-time overlay node 908. The run-time overlay node 908 may be associated with the run-time extension node 906 in a manner similar to the association of the overlay node 808 with the extension node 806. Based on the association with the run-time extension node 906, the run-time overlay node 908 may be a run-time node and may include an overlay node template 908a and an overlay node instance 908b. Various embodiments, concepts, and functionalities described in conjunction with the overlay node 808 associated with the extension node 806 may also be applicable to the run-time overlay node 908 associated with the run-time extension node 906.

The run-time extension node 914 may further include an overlay manager 910 configured to manage the association of the run-time extension node 906 with the run-time overlay node 908. The overlay manager 910 may have a description similar to the description of the overlay manager 616.

The run-time extension node 906 is further shown to implement a run-time extension node 912. The run-time extension node 912 implemented by the run-time extension node 906 may have a description similar to the extension node 812 implemented by the extension node 806. Various embodiments, concepts, and functionalities described in conjunction with the extension node 812 may also be applicable to the run-time extension node 912.

The run-time extension node 906 is further shown to be inheriting from a run-time extension node 914. The run-time extension node 914 implemented by a run-time node 916 may have a description similar to the extension node 814 implemented by the generic node 816. Various embodiments, concepts, and functionalities described in conjunction with the extension node 814 may also be applicable to the run-time extension node 914.

It will be apparent to a person skilled in the art that each run-time node, run-time extension node, and run-time overlay node depicted in FIG. 9 may include a corresponding node template and a corresponding node instance.

Various embodiments and concepts described with respect to the implementation (by way of extension operations) and application (by way of utilization operations) of the extension nodes in conjunction with the generic nodes as described in FIG. 8 are applicable for the implementation of the run-time extension nodes in conjunction with the run-time nodes described in conjunction with FIG. 9.

Additionally, loading of the run-time extension node 906 in the executable graph-based model 100, the processing circuitry (for example, the controller module 206, the memory management module 218, and the storage management module 220) may be performed by loading the extension node template 906a and the extension node instance 906b as described in conjunction with FIG. 7. Similarly, loading of the run-time nodes 902 and 904 may be performed based on loading of respective node templates and node instances as described in conjunction with FIG. 7. For example, the run-time node 902 may be loaded based on loading of the node template 902a and the node instance 902b as described in conjunction with FIG. 7.

It should be appreciated that the references to ‘first active node’ and ‘second active node,’ or other similar terms in the claims are not intended to refer to specific nodes but are used for distinguishing elements. These nodes may correspond to any of the generic nodes and/or run-time nodes described in the specification, including, but not limited to, the generic node 802, the run-time node 902, or any other applicable generic node or run-time node discussed throughout the description.

It should be appreciated that the references to ‘first extension node,’ ‘second extension node,’ or other similar terms in the claims are not intended to refer to specific extension nodes but are used for distinguishing elements. These nodes may correspond to any of the extension nodes described in the specification, including, but not limited to, the extension node 806, run-time extension node 906, or any other applicable extension node discussed herein.

Having discussed various concepts associated with implementation and application of the extension nodes in the executable graph-based model 100, the description now moves towards an exemplary implementation of the executable graph-based model 100 implementing the extension nodes.

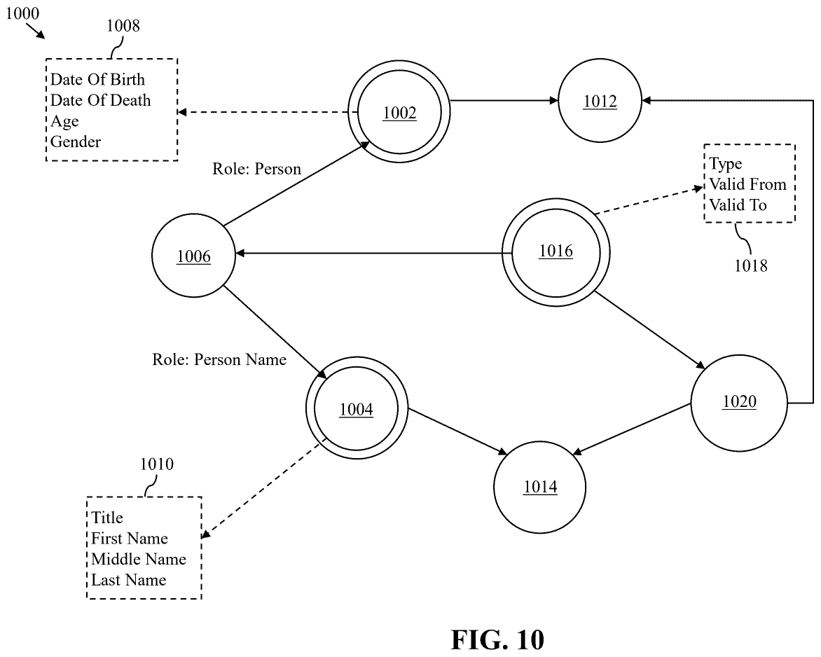

FIG. 10 illustrates a graph that depicts an employee management system 1000 implemented using the executable graph-based model 100, consistent with disclosed embodiments of the present disclosure.

Referring to FIG. 10, shown are a plurality of active nodes of the executable graph-based model 100. The plurality of active nodes may include nodes ‘Person 1002’ and ‘Name 1004’ having a vertex node-type (for example, the vertex node-type 328). The plurality of active nodes may further include a node ‘Person name 1006’ having an edge node-type (for example, the edge node-type 330). The ‘Person name 1006’ may include a role ‘Person’ for the node ‘Person 1002’ and another role ‘Person name’ for the node ‘Name 1004’. The node ‘Person name 1006’ being an edge node may couple the nodes ‘Person 1002 and ‘Name 1004’ by way of roles ‘Person’ and ‘Person name’, respectively. The executable graph-based model 100 illustrated in FIG. 10, for implementing the employee management system 1000, may have a hierarchical structure. The nodes ‘Person 1002’, ‘Name 1004’, and the ‘Person name 1006’ may not have any child nodes, and therefore, may be leaf nodes. In other words, the nodes ‘Person 1002’, ‘Name 1004’, and the ‘Person name 1006’ may correspond to leaf nodes.

The nodes ‘Person 1002’ and ‘Name 1004’ may be associated with a corresponding set of attributes. For the sake of simplicity of depiction, the sets of attributes of the nodes ‘Person 1002’ and ‘Name 1004’ are shown within dotted boxes 1008 and 1010, respectively. As shown, the set of attributes (shown within the dotted box 1008) associated with the node ‘Person 1002’ may include attributes date of birth, date of death, age, and gender. Further, the set of attributes (shown within the dotted box 1010) associated with the node ‘Name 1004’ may include attributes title, first name, middle name, and last name. Attribute values of the sets of attributes associated with the nodes ‘Person 1002’ and ‘Name 1004’ are not shown herein FIG. 10 to keep the illustration concise and clear, and should not be considered a limitation of the present disclosure.

The nodes ‘Person 1002’ and ‘Name 1004’ are shown to be associated with overlay nodes ‘Person overlay 1012’ and ‘Person name overlay 1014’, respectively. Each of the overlay nodes ‘Person overlay 1012’ and ‘Person name overlay 1014’ are assumed to be leaf overlay nodes.

In some embodiments, the overlay node ‘Person overlay 1012’ may have to be modified to include processing logic of the overlay node ‘Person name overlay 1014’. Similarly, the overlay node ‘Person name overlay 1014’ may have to be modified to include processing logic of the overlay node ‘Person overlay 1012’. In some embodiments, each of the overlay nodes ‘Person overlay 1012’ and ‘Person name overlay 1014’ may have to be modified to add a corresponding additional functionality. However, based on the overlay nodes ‘Person overlay 1012’ and ‘Person name overlay 1014’ being the leaf nodes, each of the overlay nodes ‘Person overlay 1012’ and ‘Person name overlay 1014’ may be non-inheritable and non-modifiable nodes. Also, based on the nodes ‘Person 1002’ and ‘Person name 1006’ being the leaf nodes, the nodes ‘Person 1002’ and ‘Person name 1006’ may not be inherited and hence may also be non-modifiable nodes.

Based on the nodes ‘Person 1002’ and ‘Person name 1006’, and the overlay nodes ‘Person overlay 1012’ and ‘Person name overlay 1014’ being the leaf nodes and non-modifiable nodes, the processing circuitry (for example, the controller module 206, the transaction module 208, the stimuli management module 212, or the like) may receive a fifth stimulus (for example, the stimulus 230). The fifth stimulus may be indicative of a fourth extension operation associated with the overlay system 202. The fourth extension operation may be performed for extending initial functionality ‘processing logic’ associated with each of the overlay nodes ‘Person overlay 1012’ and ‘Person name overlay 1014’.

Based on a context of the fifth stimulus, the processing circuitry (for example, the controller module 206, the transaction module 208, the extension management module 236, or the like) may be configured to identify the overlay nodes ‘Person overlay 1012’ and ‘Person name overlay 1014’ and create (namely, generate, instantiate) an extension overlay node ‘Person name extension overlay 1020’ in the executable graph-based model 100. The extension overlay node ‘Person name extension overlay 1020’ may include a fourth extended functionality that may extend a fifth initial functionality of the overlay node ‘Person overlay 1012’. In addition, the overlay node ‘Person name extension overlay 1020’ may include a fifth extended functionality that may extend a sixth initial functionality of the overlay node ‘Person name extension overlay 1020’. The processing circuitry (for example, the controller module 206, the transaction module 208, the extension management module 236, or the like) may be configured to associate the extension overlay node ‘Person name extension overlay 1020’ with each of the overlay nodes ‘Person overlay 1012’ and ‘Person name overlay 1014’. Therefore, the overlay node ‘Person overlay 1012’ may be a first source of the extension overlay node ‘Person name extension overlay 1020’ and the overlay node ‘Person name overlay 1014’ may be a second source of the extension overlay node ‘Person name extension overlay 1020’. Therefore, the extension overlay node ‘Person name extension overlay 1020’ may exhibit the fifth and sixth initial functionalities of the overlay nodes ‘Person overlay 1012’ and ‘Person name overlay 1014’, respectively. In addition, the overlay node ‘Person name extension overlay 1020’ may exhibit the fourth and fifth extended functionalities. The fourth and fifth extended functionalities may correspond to additional functionalities to be added to the overlay nodes ‘Person overlay 1012’ and ‘Person name overlay 1014’, respectively.

The processing circuitry (for example, the controller module 206, the transaction module 208, the extension management module 236, or the like), in order to make the extension overlay node ‘Person name extension overlay 1020’ accessible to the nodes ‘Person 1002’ and ‘Person name 1006’, may generate a person name extension node 1016. The person name extension node 1016 may be associated with a corresponding set of attributes shown within a dotted box 1018. The set of attributes associated with the person name extension node 1016 may include ‘attributes type’, ‘valid from’, and ‘valid to’. The attributes ‘valid from’ and ‘valid to’ may be indicative of a time period for which the node ‘Person name extension node 1016’ may be usable. The person name extension node 1016 may be associated with the node ‘Person name 1006’ such that the node ‘Person name 1006’ may be a source node of the person name extension node 1016. Therefore, the person name extension node 1016 may be used to access the nodes ‘Person 1002’ and ‘Name 1004’.

Subsequently, the processing circuitry (for example, the controller module 206, the transaction module 208, the extension management module 236, or the like) may be configured to associate the person name extension node 1016 with the extension overlay node ‘Person name extension overlay 1020’ such that the extension overlay node ‘Person name extension overlay 1020’ may be an overlay of the person name extension node 1016.

Therefore, the person name extension node 1016 may be associated with the fifth and sixth initial functionalities of the overlay nodes ‘Person overlay 1012’ and ‘Person name overlay 1014’ and the fourth and fifth extended functionalities by way of the ‘Person name extension overlay 1020’. In addition, the person name extension node 1016 may be used to access the nodes ‘Person 1002’ and ‘Name 1004’. This enables the person name extension node 1016 to add new data and/or processing logic to an initial functionality of each of the overlay nodes ‘Person overlay 1012’ and ‘Person name overlay 1014’ and the nodes ‘Person 1002’ and ‘Name 1004’.

Having described a practical implementation of the executable graph-based model 100, the description now moves towards a computing system that may facilitate such an implementation.

FIG. 11 shows an example computing system 1100 for carrying out the methods of the present disclosure, consistent with disclosed embodiments of the present disclosure. Specifically, FIG. 11 shows a block diagram of an embodiment of the computing system 1100 according to example embodiments of the present disclosure.

The computing system 1100 may be configured to perform any of the operations disclosed herein, such as for example, any of the operations discussed with reference to the functional modules described in relation to FIG. 2. The computing system 1100 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1100 is a distributed system configured to function using multiple computing machines interconnected via a data network or bus system.

The computing system 1100 includes computing devices (such as a computing device 1102). The computing device 1102 includes one or more processors (such as a processor 1104) and a memory 1106. The processor 1104 may be any general-purpose processor(s) configured to execute a set of instructions. For example, the processor 1104 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1104 may be multiple processing units, a single processing core, multiple processing cores, special purpose processing cores, co-processors, or any combination thereof. The processor 1104 may be communicatively coupled to the memory 1106 via an address bus 1108, a control bus 1110, a data bus 1112, and a messaging bus 1111.

The memory 1106 may include non-volatile memories such as a read-only memory (ROM), a programable read-only memory (PROM), an erasable programmable read-only memory (EPROM), a flash memory, or any other device capable of storing program instructions or data with or without applied power. The memory 1106 may also include volatile memories, such as a random-access memory (RAM), a static random-access memory (SRAM), a dynamic random-access memory (DRAM), and a synchronous dynamic random-access memory (SDRAM). The memory 1106 may include single or multiple memory modules. While the memory 1106 is depicted as part of the computing device 1102, a person skilled in the art will recognize that the memory 1106 can be separate from the computing device 1102.

The memory 1106 may store information that can be accessed by the processor 1104. For instance, the memory 1106 (e.g., one or more non-transitory computer-readable storage mediums, memory devices) may include computer-readable instructions (not shown) that can be executed by the processor 1104. The computer-readable instructions may be software written in any suitable programming language or may be implemented in hardware. Additionally, or alternatively, the computer-readable instructions may be executed in logically and/or virtually separate threads on the processor 1104. For example, the memory 1106 may store instructions (not shown) that when executed by the processor 1104 cause the processor 1104 to perform operations such as any of the operations and functions for which the computing system 1100 is configured, as described herein. Additionally, or alternatively, the memory 1106 may store data (not shown) that can be obtained, received, accessed, written, manipulated, created, and/or stored. The data can include, for instance, the data and/or information described herein in relation to FIGS. 1-10. In some implementations, the computing device 1102 may obtain from and/or store data in one or more memory device(s) that are remote from the computing system 1100.

The computing device 1102 may further include an input/output (I/O) interface 1116 communicatively coupled to the address bus 1108, the control bus 1110, and the data bus 1112. The data bus 1112 and messaging bus 1114 may include a plurality of tunnels that may support parallel execution of messages by the overlay system 202. The I/O interface 1116 is configured to couple to one or more external devices (e.g., to receive and send data from/to one or more external devices). Such external devices, along with the various internal devices, may also be known as peripheral devices. The I/O interface 1116 may include both electrical and physical connections for operably coupling the various peripheral devices to the computing device 1102. The I/O interface 1116 may be configured to communicate data, addresses, and control signals between the peripheral devices and the computing device 1102. The I/O interface 1116 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, Fire Wire, various video buses, or the like. The I/O interface 1116 is configured to implement only one interface or bus technology. Alternatively, the I/O interface 1116 is configured to implement multiple interfaces or bus technologies. The I/O interface 1116 may include one or more buffers for buffering transmissions between one or more external devices, internal devices, the computing device 1102, or the processor 1104. The I/O interface 1116 may couple the computing device 1102 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1116 may couple the computing device 1102 to various output devices, including video displays, speakers, printers, projectors, tactile feedback devices, automation control, robotic components, actuators, motors, fans, solenoids, valves, pumps, transmitters, signal emitters, lights, and so forth.

The computing system 1100 may further include a storage unit 1118, a network interface 1120, an input controller 1122, and an output controller 1124. The storage unit 1118, the network interface 1120, the input controller 1122, and the output controller 1124 are communicatively coupled to the central control unit (e.g., the memory 1106, the address bus 1108, the control bus 1110, and the data bus 1112) via the I/O interface 1116. The network interface 1120 communicatively couples the computing system 1100 to one or more networks such as wide area networks (WAN), local area networks (LAN), intranets, the Internet, wireless access networks, wired networks, mobile networks, telephone networks, optical networks, or combinations thereof. The network interface 1120 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1118 is a computer-readable medium, preferably a non-transitory computer-readable medium, comprising one or more programs, the one or more programs comprising instructions which when executed by the processor 1104 cause the computing system 1100 to perform the method steps of the present disclosure. Alternatively, the storage unit 1118 is a transitory computer-readable medium. The storage unit 1118 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1118 stores one or more operating systems, application programs, program modules, data, or any other information. The storage unit 1118 is part of the computing device 1102. Alternatively, the storage unit 1118 is part of one or more other computing machines that are in communication with the computing device 1102, such as servers, database servers, cloud storage, network attached storage, and so forth.

The input controller 1122 may include suitable logic, circuitry, interfaces, and/or code, executable by the circuitry, that may be configured to control one or more input devices that may be configured to receive an input (the stimulus 230) for the overlay system 202. The output controller 1124 may include suitable logic, circuitry, interfaces, and/or code, executable by the circuitry, that may be configured to control one or more output devices that may be configured to render/output the outcome of the operation executed to process the received input (the stimulus 230).

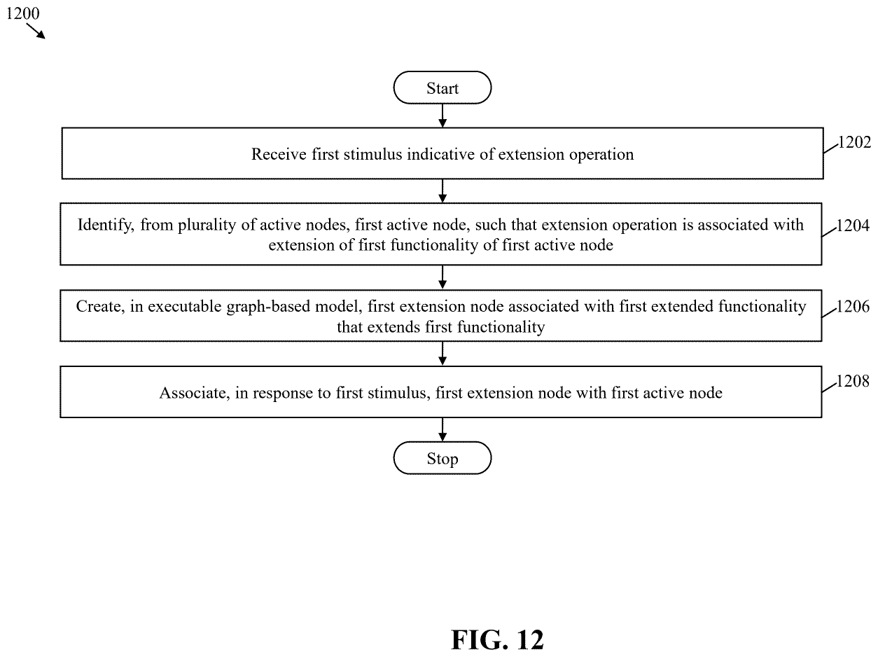

FIG. 12 illustrates a flowchart 1200 of a method for execution of an extension operation associated with a first active node in the executable graph-based model 100, consistent with disclosed embodiments of the present disclosure.

Referring to FIG. 12, at 1202, a first stimulus indicative of an extension operation may be received. The processing circuitry (for example, the controller module 206, the transaction module 208, the stimuli management module 212, or the like) may receive the first stimulus.

At 1204, a first active node (for example, the generic node 802, the run-time node 902) of the plurality of active nodes, may be identified based on the first stimulus. The processing circuitry (for example, the controller module 206, the transaction module 208, the stimuli management module 212, or the like) may identify the first active node of the plurality of active nodes based on the first stimulus. The extension operation may be associated with extension of a first functionality of the first active node.

At 1206, a first extension node (for example, the extension node 806, the run-time extension node 906) may be created in the executable graph-based model 100. The processing circuitry (for example, the controller module 206, the transaction module 208, the extension management module 236, or the like) may create the first extension node. The first extension node may be associated with the first extended functionality that extends the first functionality of the first active node.

At 1208, in response to the first stimulus, the first extension node may be associated with the first active node. The processing circuitry (for example, the controller module 206, the transaction module 208, the extension management module 236, or the like) may associate the first extension node with the first active node in response to the first stimulus. The first extension node, based on the association with the first active node, may extend the functionality of the first active node. The first extension node may exhibit the functionality of the first active node as well as the first extended functionality.

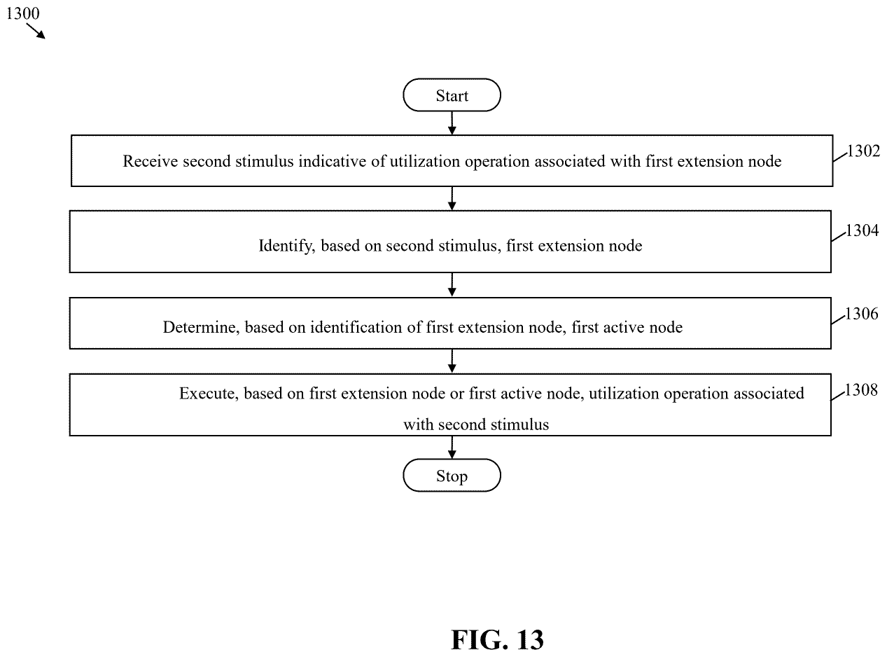

FIG. 13 illustrates a flowchart 1300 of a method for execution of a utilization operation associated with the first extension node, consistent with disclosed embodiments of the present disclosure. Referring to FIG. 13, at 1302, a second stimulus indicative of a utilization operation associated with a first extension node (for example, the extension node 806, the run-time extension node 906, or the like) may be received. The processing circuitry (for example, the controller module 206, the transaction module 208, the stimuli management module 212, or the like) may receive the second stimulus.

At 1304, the first extension node may be identified based on the second stimulus. The processing circuitry (for example, the controller module 206, the transaction module 208, the stimuli management module 212, or the like) may identify the first extension based on a context of the second stimulus.

At 1306, the first active node (for example, the generic node 802, the run-time node 902) may be determined based on the identification of the first extension node. The processing circuitry (for example, the controller module 206, the transaction module 208, the stimuli management module 212, or the like) may determine the first active node based on the association thereof with the first extension node.

At 1308, the utilization operation associated with the second stimulus may be executed based on the first extension node and/or the first active node. The processing circuitry (for example, the controller module 206, the transaction module 208, the stimuli management module 212, or the like) may execute the utilization operation based on the first extension node and/or the first active node. The utilization operation may correspond to a transaction of the overlay node 202 that may be executed based on the extended functionality of the first extension node.

The disclosed embodiments encompass numerous advantages including a simple and user-friendly implementation of the executable graph-based model 100 that may be in turn used to implement various complex and advanced applications. The disclosed overlay system 202 significantly reduces complexities related to modification of data associated with non-modifiable nodes of graph-based models. The disclosed overlay system 202 offers enhanced modifiability, allowing users to dynamically update data and/or processing logic associated with non-modifiable nodes of the executable graph-based model 100. By providing a solution to bypass the rigid constraints associated with the non-modifiable nodes, such as owned nodes, non-inheritable nodes, and leaf nodes, the overlay system 202 provides significant flexibility in adapting to evolving use cases and dynamic requirements. This ensures seamless customization, reconfiguration, and optimization of data structures of the overlay system 202. Additionally, unrestricted data modification fosters improved collaboration, enabling multiple users to interact with and update shared nodes in real-time, without the limitations of ownership-based restrictions.

Moreover, the overlay system 202 disclosed herein enhances processing efficiency associated with various transactions by reducing computational bottlenecks associated with restricted data updates, leading to faster, more optimized operations. Based on the implementation of the plurality of extension nodes, the overlay system 202 supports real-time data adaptation and improved analytical capabilities, making it more suitable for complex applications in dynamic environments. Thus, further leading to utilization of the executable graph-based model 100 to optimal capacity.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems, and methods for facilitating extension of functionalities of active nodes in the executable graph-based model. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. An overlay system, comprising:
   a storage element configured to store an executable graph-based model that includes a plurality of active nodes, with each active node having a functionality associated therewith; and
   processing circuitry that is coupled to the storage element, and configured to:
      receive a first stimulus indicative of a first extension operation;
      identify, from the plurality of active nodes, a first active node, wherein the first extension operation is associated with an extension of a first functionality of the first active node;
      create, in the executable graph-based model, a first extension node associated with a first extended functionality that extends the first functionality indicated by the first stimulus; and
      associate, in response to the first stimulus, the first extension node with the first active node, wherein the first extension node exhibits at least one of a group consisting of the first functionality or the first extended functionality.
2. The overlay system of 1, wherein the first active node is one of a group consisting of a leaf node or an owned node, of the executable graph-based model.
3. the Overlay System of 1,
   wherein the first active node is further associated with a first node-type, and
   wherein the first node-type is one of a group consisting of: an edge node-type, a vertex node-type, a role node-type, or an overlay node-type.
4. the Overlay System of 1,
   wherein the first extension node is further associated with a first extension node-type, and
   wherein the first extension node-type is one of a group consisting of: an edge extension node-type, a vertex extension node-type, a role extension node-type, or an overlay extension node-type.
5. The overlay system of 1,
   wherein the first active node is further associated with a first node-type,
   wherein the first extension node is further associated with a first extension node-type, and
   wherein the first node-type is different from the first extension node-type.
6. the Overlay System of 1,
   wherein the first active node is further associated with a first node-type,
   wherein the first extension node is further associated with a first extension node-type,
   wherein based on the first node-type being an edge node-type, the first extension node-type is an edge extension node-type,
   wherein based on the first node-type being a vertex node-type, the first extension node-type is a vertex extension node-type,
   wherein based on the first node-type being a role node-type, the first extension node-type is a role extension node-type, and
   wherein based on the first node-type being an overlay node-type, the first extension node-type is an overlay extension node-type.
7. The overlay system of 1, wherein the first extended functionality is one of a group consisting of a data functionality or an operational functionality.
8. The overlay system of 1, wherein the processing circuitry is further configured to:
   receive a second stimulus indicative of a second extension operation;
   identify, from the plurality of active nodes, the first active node, wherein the second extension operation is associated with an extension of a second functionality of the first active node;
   create, in the executable graph-based model, a second extension node associated with a second extended functionality that extends the second functionality indicated by the second stimulus; and
   associate, in response to the second stimulus, the second extension node with the first active node, wherein the second extension node exhibits at least one of a group consisting of the first functionality, the second functionality, or the second extended functionality.
9. The overlay system of 8, wherein the first extension node further exhibits the second functionality.
10. The overlay system of 1, wherein the first extension node includes a reference to the first active node.
11. The overlay system of 1, wherein based on the first extension node being loaded in the executable graph-based model, the processing circuitry is further configured to load the first active node.
12. The overlay system of 1, wherein the processing circuitry is further configured to:
   receive a third stimulus indicative of a third extension operation;
   identify, from the plurality of active nodes, a second active node, wherein the third extension operation is associated with an extension of a third functionality of the second active node;
   determine that the extension of the third functionality corresponds to the first extended functionality; and
   associate, in response to the third stimulus, the first extension node with the second active node, wherein the first extension node further exhibits the third functionality.
13. The overlay system of 12, wherein for the determination that the extension of the third functionality corresponds to the first extended functionality, the processing circuitry is configured to:
   traverse the executable graph-based model;
   compare the extension of the third functionality with the first extended functionality of the first extension node; and
   identify the first extension node based on a match of the extension of the third functionality with the first extended functionality, wherein based on the identification of the first extension node the extension of the third functionality is determined to correspond to the first extended functionality.
14. The overlay system of 12, wherein the first extension node includes a reference to at least one of a group consisting of the first active node or the second active node.
15. The overlay system of 12, wherein based on the first extension node being loaded in the executable graph-based model, the processing circuitry is further configured to load at least one of a group consisting of the first active node or the second active node.
16. The overlay system of 1, wherein the processing circuitry is further configured to:
   receive a fourth stimulus indicative of a first utilization operation associated with the first extension node;
   identify, in the executable graph-based model, based on the fourth stimulus, the first extension node;
   determine, based on the identification of the first extension node, the first active node, wherein the first active node is determined based on the association with the first extension node; and
   execute the first utilization operation based on at least one of a group consisting of the first extension node or the first active node.
17. The overlay system of 1, wherein the first active node is one of a group consisting of a generic node or a run-time node.
18. The overlay system of 17,
   wherein based on the first active node being the generic node, the first extension node corresponds to a generic extension node, and
   wherein based on the first active node being the run-time node, the first extension node corresponds to a run-time extension node.
19. the Overlay System of 18,
   wherein based on the first extension node being the run-time node, the first extension node includes an extension node template and an extension node instance, and
   wherein the extension node template corresponds to a predefined extension node structure, and the extension node instance corresponds to an implementation of the extension node template.
20. The overlay system of 19, wherein the processing circuitry is further configured to:
   receive a fifth stimulus indicative of a second utilization operation associated with the first extension node;
   determine whether the first extension node is unloaded from the executable graph-based model;
   load, based on the determination of the first extension node being unloaded from the executable graph-based model, the first extension node in the executable graph-based model; and
   execute the second utilization operation based on at least one of a group consisting of the first extension node or the first active node.
21. the Overlay System of 20,
   wherein for loading the first extension node, the processing circuitry is further configured to load the extension node template and the extension node instance, and
   wherein the extension node instance includes a reference to load the extension node template.
22. The overlay system of 21, wherein based on the loading of the first extension node, the processing circuitry is further configured to load the first active node.
23. the Overlay System of 22,
   wherein based on the first active node being the run-time node, the first active node includes a node template and a node instance,
   wherein the node template corresponds to a predefined node structure, and the node instance corresponds to an implementation of the node template, and
   wherein for loading the first active node, the processing circuitry is further configured to load the node template and the node instance, of the first active node.
24. the Overlay System of 1,
   wherein the executable graph-based model further includes a plurality of overlay nodes, and
   wherein the processing circuitry is further configured to:
   identify, based on the first stimulus, a first overlay node of the plurality of overlay nodes; and
   associate the first overlay node with the first extension node such that the first overlay node incorporates an additional functionality to the first extension node.
25. The overlay system of 24, wherein the first extension node further includes an overlay manager that manages the association of the first extension node with the first overlay node.
26. The overlay system of 1,
   wherein the processing circuitry is further configured to associate the first extension node with a third extension node of the executable graph-based model,
   wherein the third extension node is associated with a third extended functionality that extends at least one of a group consisting of the first functionality or the first extended functionality, and
   wherein a first extension node-type of the first extension node matches a third extension node-type of the third extension node.
27. the Overlay System of 1,
   wherein the processing circuitry is further configured to associate the first extension node with a fourth extension node of the executable graph-based model,
   wherein the fourth extension node is associated with a third extended functionality that extends at least one of a group consisting of the first functionality or the first extended functionality, and
   wherein a first extension node-type of the first extension node is different from a fourth extension node-type of the fourth extension node.
28. The overlay system of 1, wherein the first extension node is one of a group consisting of a stateful node or a stateless node.
29. The overlay system of 28, wherein based on the first extension node being the stateful node, the first extended functionality persists in the overlay system based on an unloading of the first extension node.
30. The overlay system of 28, wherein based on the first extension node being the stateless node, the first extended functionality ceases to exist in the overlay system based on an unloading of the first extension node.
31. a Method, Comprising:
   receiving, by processing circuitry of an overlay system, a first stimulus indicative of an extension operation,
      wherein an executable graph-based model, that includes a plurality of active nodes, is stored in a storage element of the overlay system, and
      wherein each active node of the plurality of active nodes is associated with a corresponding functionality;
   identifying, by the processing circuitry, a first active node of the plurality of active nodes, wherein the extension operation is associated with an extension of a first functionality of the first active node;
   creating, by the processing circuitry, a first extension node associated with a first extended functionality that extends the first functionality indicated by the first stimulus; and
   associating, by the processing circuitry, in response to the first stimulus, the first extension node with the first active node, wherein the first extension node exhibits at least one of a group consisting of the first functionality or the first extended functionality.
32. The method of 31, further comprising:
   receiving, by the processing circuitry, a second stimulus indicative of a utilization operation associated with the first extension node;
   identifying, by the processing circuitry, the first extension node based on the second stimulus;
   determining, by the processing circuitry, the first active node based on the identification of the first extension node, wherein the first active node is determined based on the association with the first extension node; and
   executing, by the processing circuitry, the utilization operation based on at least one of a group consisting of the first extension node or the first active node.

1. An overlay system, comprising:
a storage element configured to store an executable graph-based model that includes a plurality of active nodes, with each active node having a functionality associated therewith; and
processing circuitry that is coupled to the storage element, and configured to:
receive a first stimulus indicative of a first extension operation;
identify, from the plurality of active nodes, a first active node, wherein the first extension operation is associated with an extension of a first functionality of the first active node;
create, in the executable graph-based model, a first extension node associated with a first extended functionality that extends the first functionality indicated by the first stimulus; and
associate, in response to the first stimulus, the first extension node with the first active node, wherein the first extension node exhibits at least one of a group consisting of the first functionality or the first extended functionality.

2. The overlay system of claim 1,
wherein the first active node is further associated with a first node-type,
wherein the first extension node is further associated with a first extension node-type, and
wherein the first node-type is different from the first extension node-type.

3. The overlay system of claim 1,
wherein the first active node is further associated with a first node-type,
wherein the first extension node is further associated with a first extension node-type,
wherein based on the first node-type being an edge node-type, the first extension node-type is an edge extension node-type,
wherein based on the first node-type being a vertex node-type, the first extension node-type is a vertex extension node-type,
wherein based on the first node-type being a role node-type, the first extension node-type is a role extension node-type, and
wherein based on the first node-type being an overlay node-type, the first extension node-type is an overlay extension node-type.

4. The overlay system of claim 1, wherein the first extended functionality is one of a group consisting of a data functionality or an operational functionality.

5. The overlay system of claim 1, wherein the processing circuitry is further configured to:
receive a second stimulus indicative of a second extension operation;
identify, from the plurality of active nodes, the first active node, wherein the second extension operation is associated with an extension of a second functionality of the first active node;
create, in the executable graph-based model, a second extension node associated with a second extended functionality that extends the second functionality indicated by the second stimulus; and
associate, in response to the second stimulus, the second extension node with the first active node, wherein the second extension node exhibits at least one of a group consisting of the first functionality, the second functionality, or the second extended functionality.

6. The overlay system of claim 5, wherein the first extension node further exhibits the second functionality.

7. The overlay system of claim 1, wherein based on the first extension node being loaded in the executable graph-based model, the processing circuitry is further configured to load the first active node.

8. The overlay system of claim 1, wherein the processing circuitry is further configured to:
receive a third stimulus indicative of a third extension operation;
identify, from the plurality of active nodes, a second active node, wherein the third extension operation is associated with an extension of a third functionality of the second active node;
determine that the extension of the third functionality corresponds to the first extended functionality; and
associate, in response to the third stimulus, the first extension node with the second active node, wherein the first extension node further exhibits the third functionality.

9. The overlay system of claim 8, wherein for the determination that the extension of the third functionality corresponds to the first extended functionality, the processing circuitry is configured to:
traverse the executable graph-based model;
compare the extension of the third functionality with the first extended functionality of the first extension node; and
identify the first extension node based on a match of the extension of the third functionality with the first extended functionality, wherein based on the identification of the first extension node the extension of the third functionality is determined to correspond to the first extended functionality.

10. The overlay system of claim 1, wherein the processing circuitry is further configured to:
receive a fourth stimulus indicative of a first utilization operation associated with the first extension node;
identify, in the executable graph-based model, based on the fourth stimulus, the first extension node;
determine, based on the identification of the first extension node, the first active node, wherein the first active node is determined based on the association with the first extension node; and
execute the first utilization operation based on at least one of a group consisting of the first extension node or the first active node.

11. The overlay system of claim 1,
wherein the first active node is a run-time node,
wherein based on the first active node being the run-time node, the first extension node corresponds to a run-time extension node,
wherein the first extension node includes an extension node template and an extension node instance, and
wherein the extension node template corresponds to a predefined extension node structure, and the extension node instance corresponds to an implementation of the extension node template.

12. The overlay system of claim 11, wherein the processing circuitry is further configured to:
receive a fifth stimulus indicative of a second utilization operation associated with the first extension node;
determine whether the first extension node is unloaded from the executable graph-based model;
load, based on the determination of the first extension node being unloaded from the executable graph-based model, the first extension node in the executable graph-based model; and
execute the second utilization operation based on at least one of a group consisting of the first extension node or the first active node.

13. The overlay system of claim 12,
wherein for loading the first extension node, the processing circuitry is further configured to load the extension node template and the extension node instance, and
wherein the extension node instance includes a reference to load the extension node template.

14. The overlay system of claim 12,
wherein based on the loading of the first extension node, the processing circuitry is further configured to load the first active node,
wherein based on the first active node being the run-time node, the first active node includes a node template and a node instance,
wherein the node template corresponds to a predefined node structure, and the node instance corresponds to an implementation of the node template, and
wherein for loading the first active node, the processing circuitry is further configured to load the node template and the node instance, of the first active node.

15. The overlay system of claim 1,
wherein the executable graph-based model further includes a plurality of overlay nodes, and
wherein the processing circuitry is further configured to:
identify, based on the first stimulus, a first overlay node of the plurality of overlay nodes; and
associate the first overlay node with the first extension node such that the first overlay node incorporates an additional functionality to the first extension node.

16. The overlay system of claim 15, wherein the first extension node further includes an overlay manager that manages the association of the first extension node with the first overlay node.

17. The overlay system of claim 1,
wherein the processing circuitry is further configured to associate the first extension node with a third extension node of the executable graph-based model,
wherein the third extension node is associated with a third extended functionality that extends at least one of a group consisting of the first functionality or the first extended functionality, and
wherein a first extension node-type of the first extension node matches a third extension node-type of the third extension node.

18. The overlay system of claim 1,
wherein the processing circuitry is further configured to associate the first extension node with a fourth extension node of the executable graph-based model,
wherein the fourth extension node is associated with a third extended functionality that extends at least one of a group consisting of the first functionality or the first extended functionality, and
wherein a first extension node-type of the first extension node is different from a fourth extension node-type of the fourth extension node.

19. The overlay system of claim 1,
wherein the first extension node is one of a group consisting of a stateful node or a stateless node,
wherein based on the first extension node being the stateful node, the first extended functionality persists in the overlay system based on an unloading of the first extension node, and
wherein based on the first extension node being the stateless node, the first extended functionality ceases to exist in the overlay system based on an unloading of the first extension node.

20. A method, comprising:
receiving, by processing circuitry of an overlay system, a first stimulus indicative of an extension operation,
wherein an executable graph-based model that includes a plurality of active nodes is stored in a storage element of the overlay system, and
wherein each active node of the plurality of active nodes is associated with a corresponding functionality;
identifying, by the processing circuitry, a first active node of the plurality of active nodes, wherein the extension operation is associated with an extension of a first functionality of the first active node;
creating, by the processing circuitry, a first extension node associated with a first extended functionality that extends the first functionality indicated by the first stimulus; and
associating, by the processing circuitry, in response to the first stimulus, the first extension node with the first active node, wherein the first extension node exhibits at least one of a group consisting of the first functionality or the first extended functionality.
